(19) United States
(12) Patent Application Publication
(10) Pub. No.: US 2018/0137051 A1
(43) Pub. Date: May 17, 2018

(54) INFORMATION PROCESSING APPARATUS AND CENTRAL PROCESSING DEVICE

(71) Applicant: FUJITSU LIMITED, Kawasaki-shi (JP)

(72) Inventor: KATSUYA TSUSHITA, Saitama (JP)

(73) Assignee: FUJITSU LIMITED, Kawasaki-shi (JP)

(21) Appl. No.: 15/695,803

(22) Filed: Sep. 5, 2017

(30) Foreign Application Priority Data
Nov. 17, 2016 (JP) 2016-224202

(51) Int. Cl. G06F 12/06; G06F 12/0873; G06F 1/32

(52) U.S. Cl. CPC G06F 12/063; G06F 1/3275; G06F 12/0873

(57) ABSTRACT

An information processing apparatus includes: a central processing device; a storage device that stores a first instruction group and a second instruction group in a storage area to which a predetermined address range in an address space is assigned; and a circuit that executes predetermined arithmetic processing according to an address assigned in the address space. The central processing device includes: a program counter that designates an address; a controller that outputs an address obtained as a result of execution of the first instruction group to the program counter; and a translator including a memory that stores an address assigned to the circuit as a second address, in association with an address used for execution of the second instruction group, the address being a first address, the translator outputting the second address to the program counter when the address output from the controller matches the first address.

### CROSS-REFERENCE TO RELATED APPLICATION

This application is based upon and claims the benefit of priority of the prior Japanese Patent Application No. 2016-224202, filed on Nov. 17, 2016, the entire contents of which are incorporated herein by reference.

### FIELD

The present invention relates to an information processing apparatus and a central processing device that execute software.

### BACKGROUND

CPUs (central processing units) see an increase in power consumption as well as an increase in operating frequency, due to advancement in performance. For power consumption reduction and performance enhancement, a part of software processing to be executed by a CPU is replaced with hardware processing by, e.g., an FPGA (field-programmable gate array).

### PATENT DOCUMENTS

[Patent document 1] Japanese Patent Laid-Open No. 2004-362446

[Patent document 2] Japanese Patent Laid-Open No. 2013-50953

[Patent document 3] Japanese Patent Laid-Open No. 2008-139932

However, replacement of software processing with hardware processing causes the following problem. Where software processing is replaced with hardware processing, a memory-mapped I/O method is employed as an example of input/output (I/O) between a CPU and hardware. The memory-mapped I/O method is a method in which a memory and an interface of a hardware such as an FPGA are made to coexist on an address space that can be referred to by a CPU and the CPU gets read and write access to the interface of the hardware like the CPU gets access to the memory.

For example, where function (subroutine) processing included in a main routine is replaced with hardware, e.g., a change of an address when the function is called from the main routine to a hardware address and a change of a method of passing arguments for the function occur. Thus, replacement of software processing with hardware processing involves a change of execution codes of the software.

For example, a change of execution codes of software may involve, e.g., stoppage of the software and/or restart of the apparatus for software update. Thus, it is difficult to flexibly replace software processing with hardware processing.

### SUMMARY

One of aspects of the present invention provides an information processing apparatus including: a central processing device; a storage device that stores a first instruction group and a second instruction group in a storage area to which a predetermined address range in an address space the central processing device accesses is assigned; and a circuit that executes predetermined arithmetic processing according to an address assigned in the address space. The central processing device includes a program counter, a controller and a translator. The program counter designates an address in the address space. The controller outputs an address obtained as a result of execution of the first instruction group to the program counter. The translator includes a memory that stores an address assigned to the circuit as a second address, in association with an address used for execution of the second instruction group, the address being a first address. Also, when the address output from the controller matches the first address, the translator outputs the second address to the program counter.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a hardware configuration of an information processing apparatus according to a first embodiment;

FIG. 2 is a diagram illustrating an example of a hardware configuration of an address translation unit;

FIG. 3 is a diagram illustrating an example of a flowchart of address translation table rewrite processing;

FIG. 4 is an example of a flowchart of processing in a control unit of arithmetic processing hardware when arithmetic processing in an arithmetic processing unit is called;

FIG. 5 is an example of a flowchart of a main routine of program A in a specific example;

FIG. 6 is a diagram indicating an example of an address translation table in specific example 1;

FIG. 7 is a diagram indicating an example of an execution image of program A according to specific example 1;

FIG. 8 is a diagram indicating an example of an address translation table in specific example 2;

FIG. 9 is a diagram indicating an example of an execution image of program A according to specific example 2;

FIG. 10 is a diagram indicating an example of a hardware configuration of an information processing apparatus;

FIG. 11 is an example of a flowchart of a main routine of program A according to a comparative example;

FIG. 12 is a diagram illustrating an example of an execution image of program A according to a comparative example;

FIG. 13 is a diagram illustrating an example of a system configuration of an optical network system;

FIG. 14 is an example of a block diagram of a transmission apparatus, which is an example application of the information processing apparatus according to the first embodiment;

FIG. 15 is an example of a block diagram of a transmission apparatus, which is another example application of the information processing apparatus according to the first embodiment;

FIG. 16 is an example of a block diagram of a transmission apparatus, which is another example application of the information processing apparatus according to the first embodiment;

FIG. 17 is an example of a block diagram of a control unit included in arithmetic processing hardware of a transmission apparatus; and

FIG. 18 is an example of a flowchart of address table rewrite processing in a control unit of arithmetic processing hardware.

### DESCRIPTION OF EMBODIMENT

An embodiment of the present invention will be described below with reference to the drawings. The below embodiment is a mere example, and the present invention is not limited the configuration of the embodiment.

### First Embodiment

In a first embodiment, a CPU includes a translation unit that translates a first address to a second address, and the second address output from the translation unit is stored in a program counter as an address to be called next. The first address is, for example, an address used for calling software processing. The second address is an address assigned to arithmetic processing hardware that executes processing that is the same in content as the software processing. As a result of the CPU including the translation unit, the software processing can be replaced with hardware processing with no software execution code change.

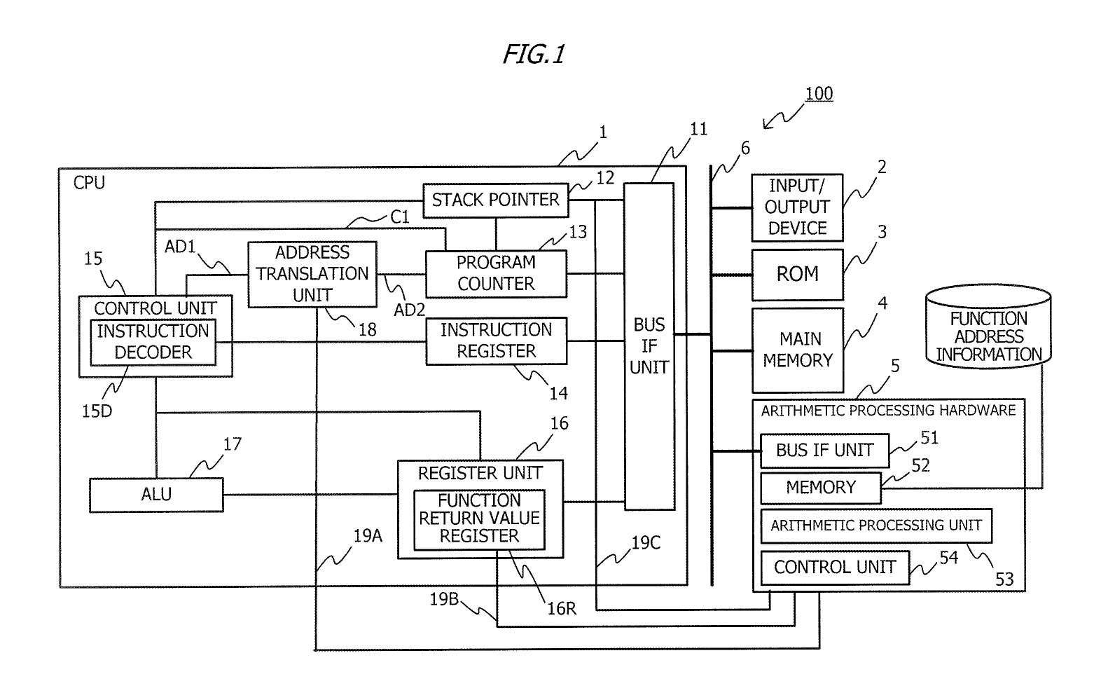

FIG. 1 is a diagram illustrating an example of a hardware configuration of an information processing apparatus according to a first embodiment. An information processing apparatus 100 includes, for example, a CPU 1, an input/output device 2, a ROM (read-only memory) 3, a main memory 4 and an arithmetic processing hardware 5, which are electrically connected via a bus 6. Although the bus 6 includes an address bus and a data bus, in FIG. 1, the bus 6 is indicated as a single line with no specific distinction between the address bus and the data bus. Also, the information processing apparatus 100 employs a memory-mapped I/O method, and addresses in a common address space are assigned to the CPU 1, the input/output device 2, a storage area on the ROM 3, a storage area on the main memory 4 and the arithmetic processing hardware 5 on the bus 6, respectively.

The input/output device 2 includes, for example, an input device such as a keyboard or a mouse and an output device such as a display.

The ROM 3 is a non-rewritable, non-volatile memory. In the ROM 3, e.g., non-rewritable predetermined programs and data are stored.

The main memory 4 is a RAM (random access memory). In the main memory 4, a program read from the ROM 3 or a non-illustrated auxiliary storage device is loaded. In other words, in the main memory 4, e.g., codes and data included in the program are stored. The codes are also referred to as instructions. Each of the codes is an example of “instruction”. A code group corresponding to a subroutine for calling a main routine or another subroutine of software loaded on the main memory 4 is, for example, an example of “a first instruction group”. A code group corresponding to a subroutine to be called by a main routine or another subroutine of the software loaded on the main memory 4 is, for example, an example of “a second instruction group”.

The arithmetic processing hardware 5 is, for example, an FPGA. The arithmetic processing hardware 5 includes a bus interface (IF) unit 51, a memory 52, an arithmetic processing unit 53 and a control unit 54. Each of the bus IF unit 51, the memory 52, the arithmetic processing unit 53 and the control unit 54 is a circuit built by an element mounted on the FPGA. On the FPGA, for example, a RAM, a lookup table, a flip-flop, and logical arithmetic circuits such as AND and XOR are mounted.

The bus IF unit 51 is an interface with the bus 6. An address in an address space on the bus 6 is assigned to the bus IF unit 51. The number of addresses assigned to the bus IF unit 51 is not limited to one, and a predetermined address range may be assigned to the bus IF unit 51.

The memory 52 is, for example, a RAM. In the memory 52, function address information is stored. The function address information includes addresses in a storage area of the main memory 4 at which subroutines such as functions for the arithmetic processing unit 53 included in the arithmetic processing hardware 5 are stored.

The arithmetic processing unit 53 is an arithmetic circuit that executes predetermined arithmetic processing. If the address assigned to the bus IF unit 51 is called, the arithmetic processing unit 53 executes predetermined arithmetic processing. In the first embodiment, arithmetic processing executed by the arithmetic processing unit 53 is arithmetic processing that is the same as that of a subroutine stored in the main memory 4.

The control unit 54 performs, e.g., processing for rewriting an address translation table in an address translation unit 18 of the later-described CPU 1, and acquisition of data to be used for an arithmetic operation in the arithmetic processing unit 53 in the case where arithmetic processing in the arithmetic processing unit 53 is called and output of a result of the arithmetic operation. The address translation table rewrite processing is executed, for example, when a predetermined condition is met. The condition for executing address translation table rewrite processing is defined according to, for example, a change in hardware configuration of the information processing apparatus 100, a temperature, a load status of the CPU 1, and/or a type of data to be processed. Details of processing in the control unit 54 will be described later.

The CPU 1 includes a bus IF unit 11, a stack pointer 12, a program counter 13, an instruction register 14, a control unit 15, a register unit 16, an ALU (arithmetic and logic unit) 17 and an address translation unit 18. Each of these components is a circuit built by an element mounted on the CPU 1.

The bus IF unit 11 is an interface with the bus 6. An address in the address space on the bus 6 is assigned to the bus IF unit 11. An address or/and data are input to the bus IF unit 11 from, for example, the stack pointer 12, the program counter 13 and/or the register unit 16. The address or/and data input from, for example, the stack pointer 12, the program counter 13 and/or the register unit 16 are output from the bus IF unit 11 to the bus 6.

A code and/or data corresponding to the address output to the bus 6 are input to the bus IF unit 11 from the bus 6. For example, an address is input to the bus IF unit 11 from the program counter 13. The address input to the program counter 13 is output from the bus IF unit 11 to the bus 6. A code corresponding the address is input from hardware, to which the address output to the bus 6 is assigned, to the bus IF unit 11 through the bus 6. The code input from the bus 6 to the bus IF unit 11 is output (fetched) from the bus IF unit 11 to the instruction register 14.

The instruction register 14 is, for example, a storage circuit that temporarily stores a code read from the main memory 4. The instruction register 14 outputs the held code to the control unit 15.

The control unit 15 is a circuit that performs processing according to a processing content indicated by the code input from the instruction register 14. The control unit 15 includes an instruction decoder 15D. The instruction decoder 15D decodes the code input from the instruction register 14 and acquires control information included in the code. The control unit 15 performs processing according to the control information acquired by the instruction decoder 15D.

For example, if an arithmetic operation such as any of four arithmetic operations is included in the processing content in the control information acquired by the instruction decoder 15D, the control information is output from the control unit 15 to the ALU 17, and arithmetic processing is performed in the ALU 17. A result of the arithmetic operation in the ALU 17 is written to the register unit 16.

For example, if the processing content in the control information acquired by the instruction decoder 15D is data transmission/reception inside the CPU 1, data transmission/reception between the CPU 1 and hardware outside the CPU 1 or processing not handling data, the control unit 15 executes the designated processing. If data is acquired as a result of the execution of the processing, the execution result data is written to the register unit 16 by the control unit 15. Then, if arithmetic processing by the ALU 17 occurs, data of a result of the arithmetic operation is written from the ALU 17 to the register unit 16.

If an address is acquired as a result of the execution of the processing, the acquired address is output from the control unit 15 to an address signal line AD1 connected to the address translation unit 18. A case where an address is acquired as an execution result is, for example, a case where the code input from the instruction register 14 is, e.g., a CALL instruction for calling a subroutine, a JUMP instruction for movement to a designated address or a RETURN instruction for return to a caller address.

For example, if the code input from the instruction register 14 is a branch instruction such as a CALL instruction, a control signal is output from the control unit 15 to the stack pointer 12. The stack pointer 12 is a register that holds an address of a stack area. The control unit 15 writes a return address and the data held in the register unit 16 to a stack area of the address indicated by the stack pointer 12. The return address written to the stack area is, for example, an address obtained by addition of the number of words (for example, 1) of the branch instruction to an address held in the program counter 13 immediately before a branch to a subroutine according to the branch instruction. The data held in the register unit 16, which is written to the stack area, is, for example, data of the main routine or the subroutine immediately before the subroutine is executed in response to the branch instruction. In the first embodiment, a JUMP instruction may be included in the branch instruction.

Upon completion of the processing, a control signal representing the completion of the processing is output from the control unit 15 to a control signal line C1 connected to the program counter 13.

The address translation unit 18 translates a first address input from the control unit 15 into a second address. The first address is hereinafter also referred to as “pre-translation address”. The second address is hereinafter also referred to as “post-translation address”.

The address translation unit 18 includes a RAM that stores the second address associated with the first address. The address translation unit 18 is connected to the control unit 15 and the program counter 13 via address signal line AD1 and AD2, respectively. An address is input from the control unit 15 to the address translation unit 18 through the address signal line AD1. If the address input from the control unit 15 matches the first address, the second address is output from the address translation unit 18 to the program counter 13 through the address signal line AD2. If the address input from the control unit 15 does not match the first address, the address input from the control unit 15 is output, as it is, from the address translation unit 18 to the program counter 13 through the address signal line AD2. Details of the address translation unit 18 will be described later.

The program counter 13 is a storage circuit that holds an address of a called code. The program counter 13 is, for example, a register. Upon input of a control signal of completion of execution from the control unit 15 to the program counter 13 through the control signal line C1, the program counter 13 counts up a held address value by the number of words included in the code, the execution of which has been completed. Upon input of an address to the program counter 13 through the address signal line AD2, the program counter 13 rewrites the held address value to the input address. At a next clock, the program counter 13 outputs the held address to the bus IF unit 11.

The stack pointer 12 is a pointer that holds an address referred to last in a stack area of the main memory 4. The stack area is a storage area secured in the main memory 4. If a new subroutine is called, data of the main routine or a subroutine executed immediately before the new subroutine is called and a value of the program counter 13 are temporarily saved in the stack area. The stack area is an area that enables data stored last to be retrieved first (first-in, last-out).

The ALU 17 is a logical arithmetic circuit for, e.g., four arithmetic operations and product-sum operations. The register unit 16 is a storage circuit that stores a result of execution of a code. The register unit 16 includes a plurality of general-purpose registers. Data obtained as a result of processing from the control unit 15 or the ALU 17 is input to, or data transmitted/received according to a WRITE instruction or a READ instruction is stored in, the register unit 16. One or more registers of the plurality of general-purpose registers included in the register unit 16 are used as a function return value register 16R. A result of processing of a subroutine is written to the function return value register 16R. Examples of the result of processing written to the function return value register 16R include, e.g., a value of a result of an arithmetic operation and success or failure of processing.

In the first embodiment, the control unit 54 of the arithmetic processing hardware 5 can perform reading/rewriting from/to the main memory 4 via the bus IF unit 51. Therefore, in the first embodiment, the main memory 4 includes two ports, which are a port to the bus 6 and a port to a bus connected to the arithmetic processing hardware 5 (thus is made as a dual-port memory). Or, for example, allocation of time units for access to the main memory 4 via the bus 6 may be determined for each of the CPU 1 and the arithmetic processing hardware 5 to prevent conflict of access to the main memory 4 between the CPU 1 and the arithmetic processing hardware 5.

Also, in the first embodiment, the stack pointer 12 and the control unit 54 of the arithmetic processing hardware 5 are connected via a signal line 19C. The control unit 54 of the arithmetic processing hardware 5 acquires an address output from the stack pointer 12 (address in the stack pointer 12) through the signal line 19C, and each time the address is acquired, the address is rewritten to the acquired address and stored in the control unit 54. If an address of the arithmetic processing hardware 5 (arithmetic processing in the arithmetic processing unit 53) is called, the control unit 54 reads data to be used for the arithmetic processing called by the CPU 1, from a storage area in the stack area, the storage area corresponding to the address of the stack pointer 12 held in the control unit 54.

Also, in the first embodiment, the control unit 54 of the arithmetic processing hardware 5 and the function return value register 16R of the CPU 1 are connected via a signal line 19B. The control unit 54 of the arithmetic processing hardware 5 writes a result of processing by a called function directly to the function return value register 16R of the CPU 1 through the signal line 19B. Also, if success/failure, which is a result of processing of a function, is written to the function return value register 16R and a value of the result of the arithmetic operation of the function is used as an argument, the control unit 54 of the arithmetic processing hardware 5 may write the result of the arithmetic operation of the function to a storage area for storing arguments of functions in the main memory 4.

Also, in the first embodiment, the control unit 54 of the arithmetic processing hardware 5 and the RAM (later-described address memory 18M) that holds a second address (post-translation address) in the address translation unit 18 of the CPU 1 are connected via a signal line 19A. If a predetermined condition is met, the control unit 54 of the arithmetic processing hardware 5 rewrites the second address (post-translation address) held on the RAM in the address translation unit 18, through the signal line 19A.

The information processing apparatus 100 is an example of “an information processing apparatus”. The CPU 1 is an example of “a central processing device”. The main memory 4 is an example of “a storage device”. The arithmetic processing hardware 5 is an example of “a circuit”. The address space on the bus 6 is an example of “an address space the central processing device accesses”.

The program counter 13 of the CPU 1 is an example of “a program counter”. The control unit 15 of the CPU 1 is an example of “a controller”. The address translation unit 18 of the CPU 1 is an example of “a translator”. The stack pointer 12 of the CPU 1 is an example of “an address holder”. The function return value register 16R is an example of “a register”.

The arithmetic processing unit 53 of the arithmetic processing hardware 5 is an example of “an arithmetic processing circuit”. The control unit 54 of the arithmetic processing hardware 5 is an example of “a control circuit”.

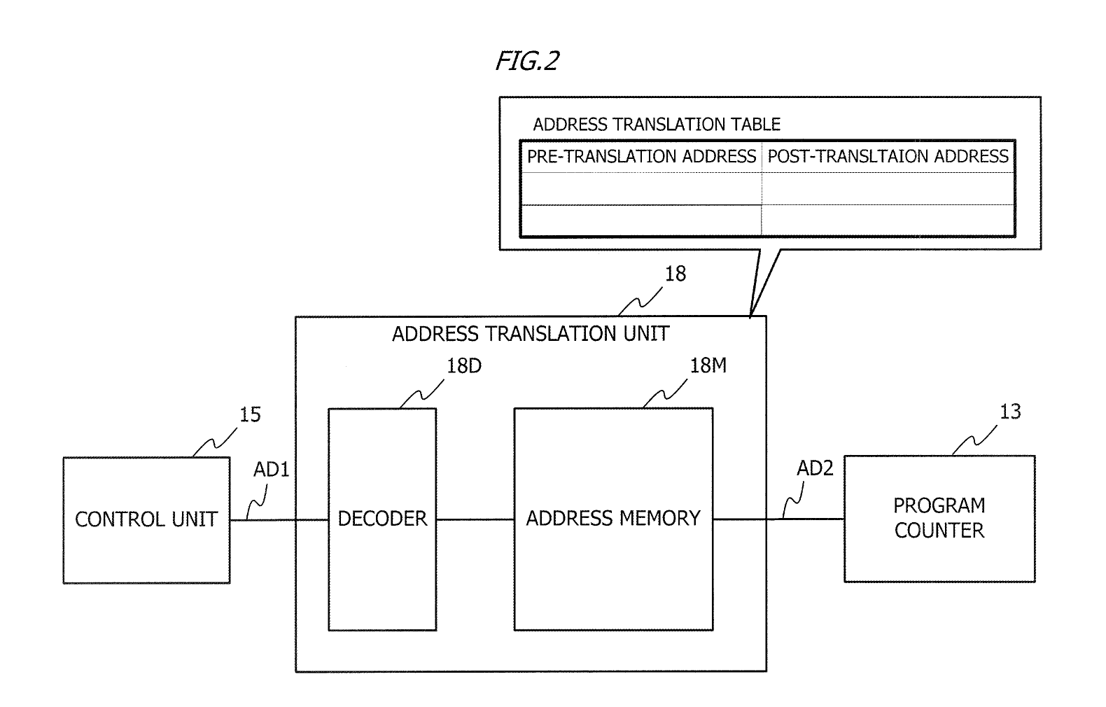

FIG. 2 is a diagram illustrating an example of a hardware configuration of the address translation unit 18. The address translation unit 18 includes a decoder 18D and the address memory 18M.

The address memory 18M is the RAM in the address translation unit 18. The address memory 18M has, for example, an address space that is different from the address space on the bus 6. An address in the address space on the bus 6 can be associated with an address in the address space of the address memory 18M according to a predetermined algorithm. Hereinafter, an address in the address space on the bus 6 is simply referred to as an address on the bus 6. An address in the address space in the address memory 18M is simply referred to as an address in the address memory 18M.

In the address memory 18M, at a storage area for an address in the address memory 18M, the address being associated with a first address (pre-translation address) on the bus 6, a second address (post-translation address) on the bus 6 is stored as data.

The decoder 18D is a circuit that translates an address on the bus 6 into an address in the address memory 18M. An address on the bus 6 is input to the decoder 18D from the control unit 15 through the address signal line AD1. From the decoder 18D to the address memory 18M, an address in the address memory 18M is output, the address being associated with the input address on the bus 6, and the address being obtained as a result of translation of the input address on the bus 6 by the decoder 18D.

To the address memory 18M, the address in the address memory 18M is input from the decoder 18D, the address being obtained as a result of the translation by the decoder 18D. From the address memory 18M, the address on the bus 6 is output, the address is data stored in a storage area for the address in the address memory 18M which is input from the decoder 18D. Since the address memory 18M is connected to the program counter 13 via the address signal line AD2, the address on the bus 6 output from the address memory 18M is output to the program counter 13.

Therefore, because an address on the bus 6 which is different from an address on the bus 6 corresponding to an address in the address memory 18M is stored in a storage area in the address memory 18M, a pre-translation address and a post-translation address have different values and address translation is thus performed by the address translation unit 18. If an address on the bus 6 corresponding to an address in the address memory 18M is stored in a storage area of the address memory 18M, a pre-translation address and a post-translation address have a same value and no address translation is thus performed.

Therefore, the address translation unit 18 functions as an address translation table that stores an association between a pre-translation address and a post-translation address, and upon input of an address that is the pre-translation address, outputs the corresponding post-translation address. Hereinafter, the address translation unit 18 may be referred to as “address translation table”. Also, rewriting the address memory 18M may be referred to as rewriting the address translation table.

In the first embodiment, in an initial state, in each storage area of the address memory 18M, an address on the bus 6 associated with a relevant address in the address memory 18M is stored. In other words, in an initial state, each address input to the address translation unit 18 is output without being translated.

In reality, it is difficult to secure storage areas of the address memory 18M so that all of addresses on the bus 6 are stored. Thus, in the first embodiment, addresses on the bus 6 that are likely to be subjected to address translation are extracted in advance, and on the address memory 18M, storage areas are prepared for the addresses on the bus 6 that are likely to be subjected to address translation. The decoder 18D is connected to the program counter 13 via a non-illustrated signal line. The decoder 18D determines whether or not an address input from the control unit 15 is an address that is likely to be subjected to address translation, and if the address is not an address that is likely to be subjected to address translation, outputs the input address as it is to the signal line connected to the program counter 13. Therefore, an address other than the addresses that are likely to be subjected to address translation, the addresses being extracted in advance, is not translated by the address translation unit 18. Here, even in the case of an address that is likely to be subjected to address translation, an address that is the same as a pre-translation address is stored in the address memory 18M as a post-translation address (for example, an initial state), the address is not subjected to translation.

The address memory 18M is an example of “a memory” included in “a translator”. A pre-translation address in the address translation table is an example of “a first address”. Each of a post-translation address in the address translation table and an address stored in the address memory 18M is an example of “a second address”.

<Flow of Processing>

In the first embodiment, examples of processing executed by the control unit 54 of the arithmetic processing hardware 5 include processing for rewriting the address translation table, and processing where arithmetic processing in the arithmetic processing unit 53 is called.

A post-translation address in the address translation table is rewritten from/to the address of the arithmetic processing hardware 5 to/from an address of a storage area for storing a body of a subroutine in the main memory 4, whereby processing for the subroutine can dynamically switched between software processing and hardware processing. The address translation table is a functional concept, and in reality, corresponds to the address translation unit 18. Rewriting the address translation table corresponds to rewriting an address stored in the address memory 18M.

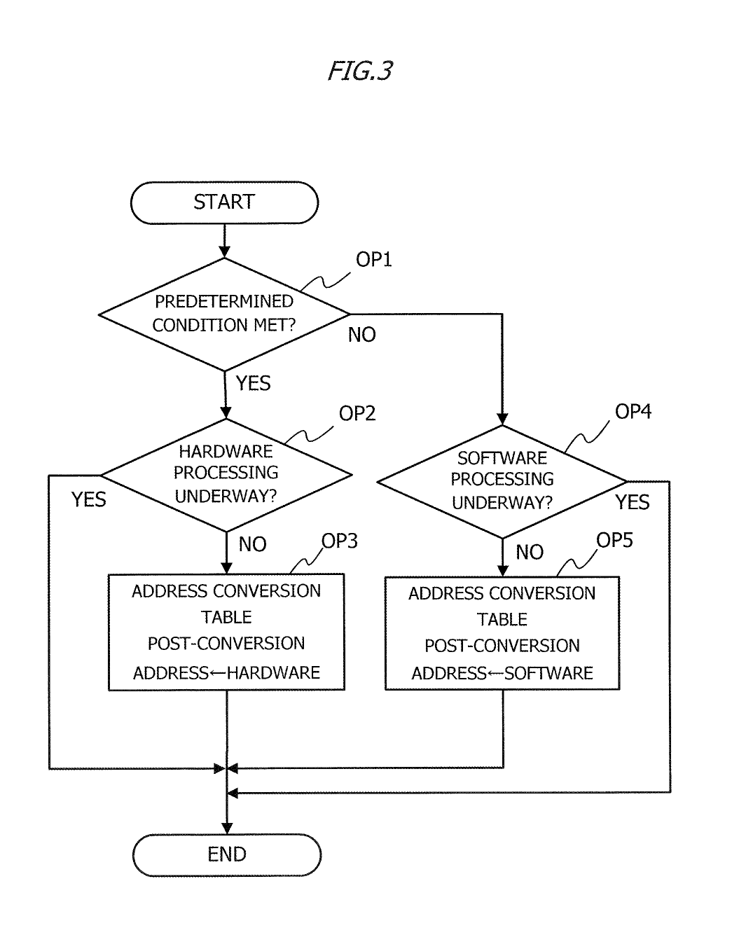

FIG. 3 is a diagram illustrating an example of a flowchart of processing for rewriting the address translation table. The flowchart illustrated in FIG. 3 is a flowchart where processing for a target subroutine is dynamically switched between software processing and hardware processing. In the first embodiment, the processing illustrated in FIG. 3 is executed by the control unit 54 of the arithmetic processing hardware 5. The processing in FIG. 3 is repeatedly executed during operation of the information processing apparatus 100.

In OP1, the control unit 54 determines whether or not a predetermined condition is met. The predetermined condition is defined in advance according to, for example, environmental conditions such as a temperature and/or a processing load on the CPU 1. If the predetermined condition is met (OP1: YES), the processing proceeds to OP2. If the predetermined condition is not met (OP1: NO), the processing proceeds to OP4.

In OP2, the control unit 54 determines whether or not the target subroutine processing is being subjected to hardware processing. Whether the target subroutine processing is being performed as hardware processing or software processing is held by, for example, a flag in the control unit 54. If the target subroutine processing is being performed as hardware processing (OP2: YES), the processing in FIG. 3 ends. The target subroutine processing is being performed as software processing (OP2: NO), the processing proceeds to OP3.

In OP3, the control unit 54 writes the address of the arithmetic processing hardware 5 as a post-translation address to an entry in the address translation table, a pre-translation address in the entry being an address, in the main memory 4, at which a body of the target subroutine is stored. In reality, the address of the arithmetic processing hardware 5 is written to an area for an address in the address memory 18M, the area being in the address memory 18M of the address translation unit 18, the address corresponding to the address (on the bus 6) of the storage area for a body of the target subroutine in the main memory 4. The address of the storage area for storing a body of the target subroutine in the main memory 4 is included in the function address information stored in the memory 52 of the arithmetic processing hardware 5. Also, the control unit 54 changes the flag to a value indicating that the target subroutine processing is being performed as hardware processing. Subsequently, the processing illustrated in FIG. 3 ends.

In OP4, the control unit 54 determines whether or not the target subroutine processing is being performed as software processing. If the target subroutine processing is being performed as software processing (OP4: YES), the processing illustrated in FIG. 3 ends. If the target subroutine processing is being performed as hardware processing (OP4: NO), the processing proceeds to OP5.

In OP5, the control unit 54 writes the address of the storage area for the body of the target subroutine in the main memory 4 as a post-translation address to the entry in the address translation table, the pre-translation address in the entry being the address of the storage area for the body of the target subroutine in the main memory 4. In reality, the address of the storage area for the body of the target subroutine in the main memory 4 is written to the area for the address in the address memory 18M of the address translation unit 18, the address being the address in the address memory 18M corresponding to the address (on the bus 6) in the storage area for the body of the target subroutine. Also, the control unit 54 changes the flag to a value indicating that the target subroutine processing is being performed as software processing. Subsequently, the processing illustrated in FIG. 3 ends.

Here, the predetermined condition in OP1 may be, e.g., an input of an instruction for switching to hardware processing or software processing from an administrator or detection of connection to the information processing apparatus 100.

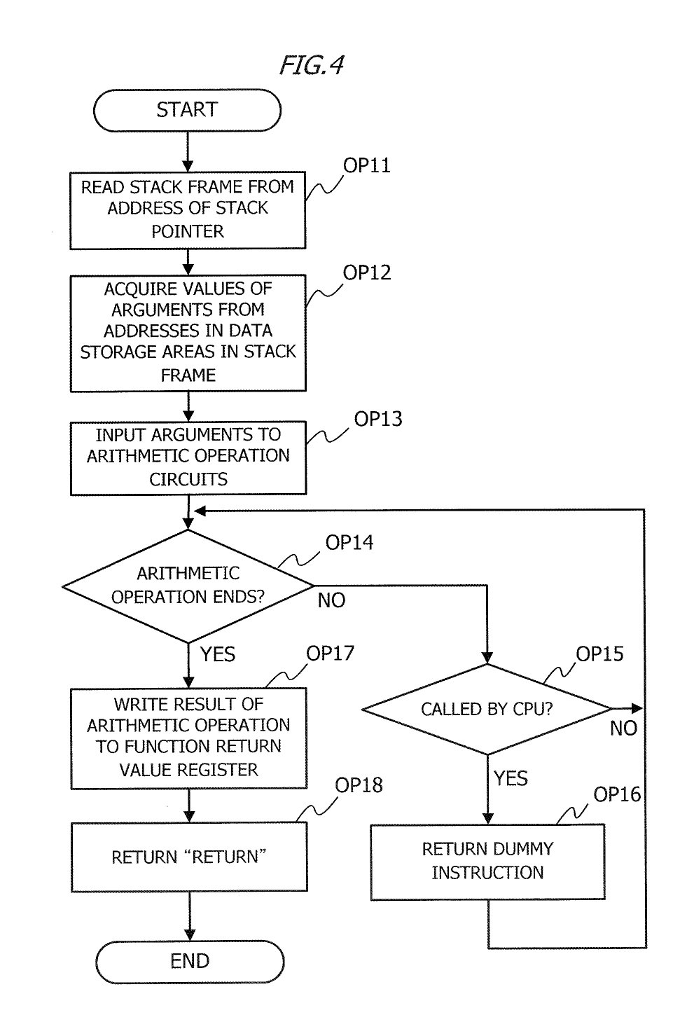

FIG. 4 is an example of a flowchart of processing in the control unit 54 of the arithmetic processing hardware 5 where arithmetic processing in the arithmetic processing unit 53 is called. The processing illustrated in FIG. 4 is started if the address assigned to the arithmetic processing hardware 5 is called by the CPU 1.

In OP11, the control unit 54 reads a stack frame from an area in the stack area, the area being indicated by the address of the stack pointer 12 held in the control unit 54.

In OP12, the control unit 54 refers to an address of a data storage area stored in the stack frame, and reads, e.g., value of arguments to be used for arithmetic processing in the arithmetic processing unit 53 from the relevant area in the main memory 4. In OP13, the control unit 54 inputs the read values of the arguments to the arithmetic processing unit 53.

In OP14, the control unit 54 determines whether or not arithmetic processing in the arithmetic processing unit 53 ends. If a result of an arithmetic operation is output from the arithmetic processing unit 53, it is determined that the arithmetic processing ends. If the arithmetic processing in the arithmetic processing unit 53 does not end (OP14: NO), the processing proceeds to OP15. If the arithmetic processing in the arithmetic processing unit 53 ends (OP14: YES), the processing proceeds to OP17.

In OP15, if the control unit 54 detects that the address assigned to the arithmetic processing hardware 5 is called (OP15: YES), the processing proceeds to OP16. If the address assigned to the arithmetic processing hardware 5 is not called (OP15: NO), the processing proceeds to OP14.

In OP16, since the address assigned to the arithmetic processing hardware 5 is called during execution of the arithmetic processing in the arithmetic processing unit 53, the control unit 54 returns a dummy instruction to the CPU 1 to prevent the processing from returning to the main routine. The dummy instruction is, for example, a JUMP instruction designating an address assigned to the arithmetic processing unit 53.

Upon the return of the dummy instruction, the processing proceeds to OP14. Until end of the arithmetic processing in the arithmetic processing unit 53, the processing from OP14 to OP16 is repeated.

Here, an NOP instruction or a LOOP instruction designating the address assigned to the arithmetic processing unit 53 may be used as the dummy instruction. An NOP instruction is an instruction for nothing to be done. For example, a predetermined address range may be assigned to the arithmetic processing hardware 5. For example, if an NOP instruction is used as the dummy instruction, an increase in address held by the program counter 13 in the CPU 1 is caused by the NOP instruction, resulting in change of an address from which a code is read by the CPU 1. In this case, also, if the address called by the CPU 1 falls within the address range assigned to the arithmetic processing hardware 5, the control unit 54 can continue returning the dummy instruction to the CPU 1.

If an NOP instruction is used as the dummy instruction and the address held by the program counter 13 reaches a predetermined address close to a tail end of the address range assigned to the arithmetic processing hardware 5, the control unit 54 returns, for example, a JUMP instruction designating an address close to a head in the address range. Consequently, for example, even if arithmetic processing in the arithmetic processing unit 53 consumes much time and the address held by the program counter 13 is likely to exceed the address range assigned to the arithmetic processing hardware 5, the processing can be prevented from returning to the main routine.

In OP17, since the arithmetic processing in the arithmetic processing unit 53 ends, the control unit 54 writes a result of the arithmetic operation to the function return value register 16R of the CPU 1 via the signal line 19B. If arguments are passed as a result of the arithmetic processing, the control unit 54 updates storage areas for values of arguments x, y, z in the main memory 4. In OP18, the control unit 54 returns a RETURN instruction to the CPU 1. Subsequently, the processing illustrated in FIG. 4 ends.

### SPECIFIC EXAMPLES

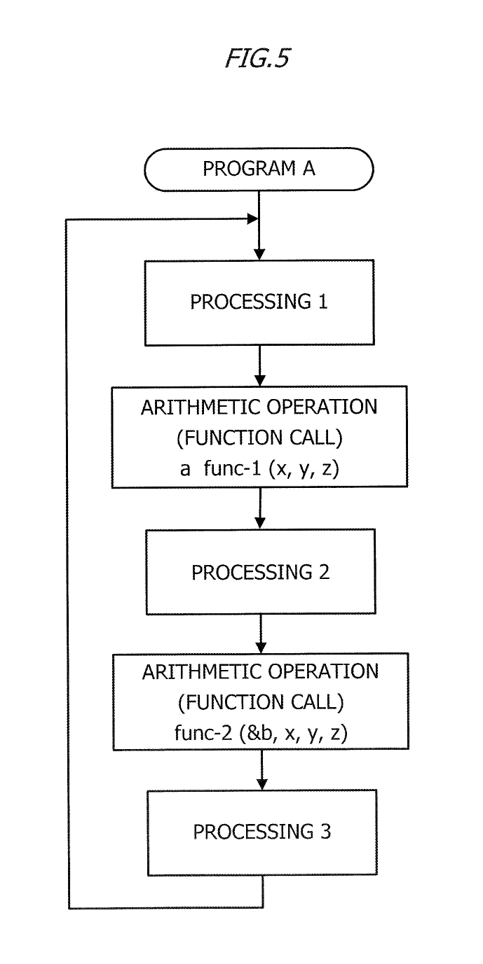

FIG. 5 is an example of a flowchart of a main routine of program A in a specific example. Program A is loaded in the main memory 4. Codes of the main routine of program A are stored in consecutive storage areas in the main memory 4.

In program A, processing is performed in the order of processing 1, arithmetic processing for a function func-1, processing 2, arithmetic processing for a function func-2 and processing 3. The flowchart of the main routine of program A illustrated in FIG. 5 is one made on the assumption that the arithmetic processing for the function func-1 and the arithmetic processing for the function func-2 are performed as software processing.

It is assumed that x, y, z are arguments of the function func-1 (in the figure, func-1(x,y,z)). It is assumed that x, y, z and an arithmetic operation result b of an arithmetic operation of the function func-2 are arguments of the function func-2 (in the figure, func-2(&b,x,y,z)).

In specific example 1, it is assumed that for the function func-1, software processing is replaced by hardware processing. In specific example 2, it is assumed that for the function func-1 and the function func-2, software processing is replaced by hardware processing.

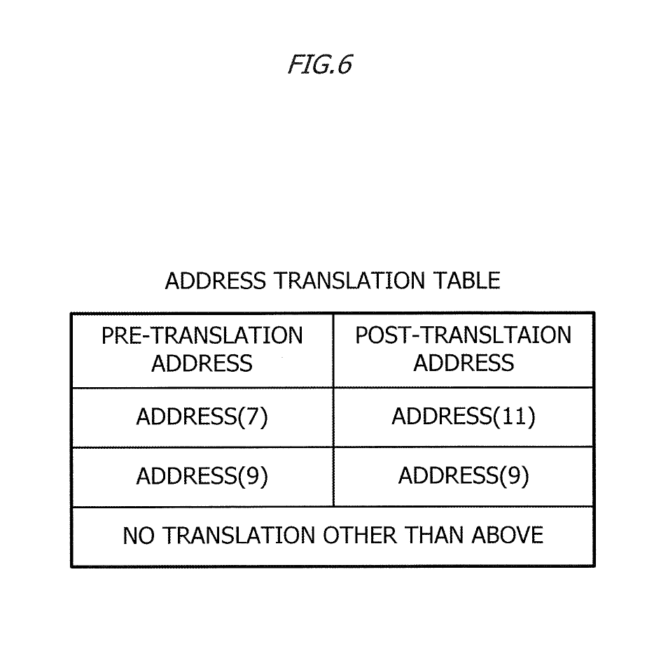

FIG. 6 is a diagram illustrating an example of an address translation table in specific example 1. In specific example 1, for the function func-1, software processing is replaced by hardware processing, and thus, address (7), in the main memory 4, at which the function func-1 is stored, as a pre-translation address, and address (11) assigned to the arithmetic processing hardware 5, as a post-translation address, are associated with each other. Since the function func-2 is executed by software processing, address (9), in the main memory 4, at which the function func-2 is stored is stored as each of a pre-translation address and a post-translation address.

Here, in reality, address (11) on the bus 6 is stored in a storage area for an address, in the address memory 18M in the translation unit 18, associated with address (7) on the bus 6. Address (9) on the bus 6 is stored in a storage area for an address, in the address memory 18M in the address translation unit 18, associated with address (9) on the bus 6.

In specific example 1, program A is an example of “a first instruction group”. In specific example 1, a body (code group) of the function func-1 in the main memory 4 is an example of “a second instruction group”. In specific example 1, the address of the storage area for storing the body of the function func-1 in the main memory 4 is an example of “an address to be used for execution of the second instruction group”. In specific example 1, the address of the arithmetic processing hardware 5 is an example of “an address assigned to the circuit”.

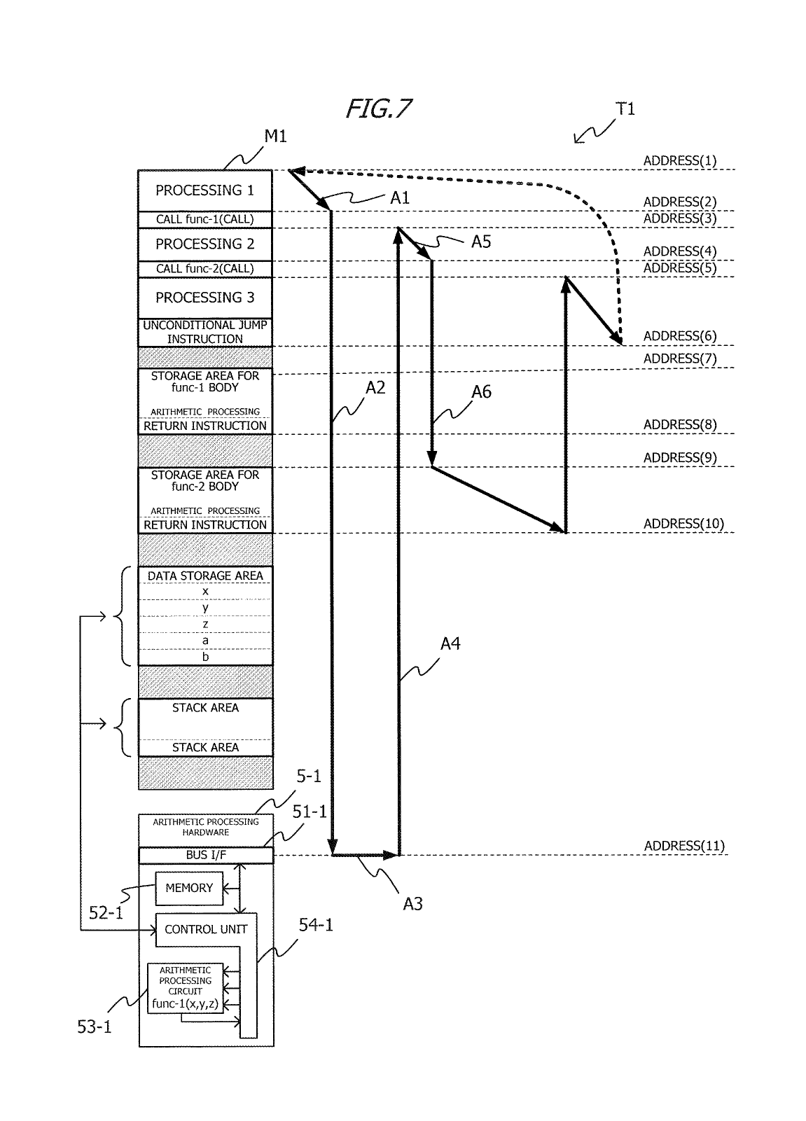

FIG. 7 is a diagram illustrating an example of an execution image T1 of program A according to specific example 1. Also, in FIG. 7, a storage image M1 of a program in the main memory 4 and arithmetic processing hardware 5-1 are illustrated. The arithmetic processing hardware 5-1 illustrated in FIG. 7 is indicated from a functional perspective.

In the storage image M1 of a program in the main memory 4, which is illustrated in FIG. 7, for simplicity, one address is provided for one code group for, e.g., processing 1. However, in reality, a storage area for one address is sometimes insufficient to hold one code group, and thus, a predetermined address range may be assigned to one code group.

In FIG. 7, the codes of the main routine of program A are stored in an address range of addresses (1) to (5). The body (code group) of the function func-1 is stored at address (7). A body (code group) of the function func-2 is stored at address (9). Address (11) is assigned to the arithmetic processing hardware 5.

The arithmetic processing hardware 5-1 includes an arithmetic processing unit 53-1, which is an arithmetic circuit for the function func-1.

In A1, the CPU 1 starts execution of program A. When the CPU 1 executes program A, head address (1) of the address range of (1) to (5) in which the code group of program A is stored is set in the program counter 13. Codes stored at address (1) designated by the program counter 13 are read from the main memory 4 and stored (fetched) into the instruction register 14. The codes read from the address (1) are decoded by the instruction decoder 15D, and the control unit 15 executes processing according to control information including a processing content of processing 1.

Upon end of processing 1, the control unit 15 outputs a signal of processing completion to the program counter 13 through the control signal line C1. Upon receipt of the signal of processing completion from the control unit 15 through the control signal line C1, the program counter 13 counts up held address (1) to set address (2). Subsequently, as in the above, codes are read from an address designated in the program counter 13 and processing for program A is executed.

In A2, a CALL instruction for the function func-1, which is stored at address (2), is executed. In the CALL instruction for the function func-1, address (7) of the storage area for the body of the function func-1 in the main memory 4 is designated.

Upon execution of the CALL instruction for the function func-1 by the control unit 15 of the CPU 1, a control signal is output from the control unit 15 to the stack pointer 12. In the stack pointer 12, as an initial value, for example, a largest address in the address range in the main memory 4, which is assigned as a stack area, is held. In response to the control signal input from the control unit 15, the address in the stack area held in the stack pointer 12 is updated to a value obtained by subtracting a value corresponding to an amount of data stored in the stack area from the held address in the stack area. An address indicated by the stack pointer 12 after the update is a head address in an area, in the stack area, in which data of the main routine is stored.

Also, upon execution of the CALL instruction for the function func-1 by the control unit 15 of the CPU 1, the control unit 15 causes a return address and data of the main routine to be stored in an area, in the stack area, indicated by the address of the stack pointer 12 after the update. A set of the return address and data for a main routine or a subroutine immediately before processing branches is referred to as a stack frame. The return address is a value obtained by addition of 1 to an address held in the program counter 13 at a point of time of execution of the CALL instruction for the function func-1 by the control unit 15 of the CPU 1. The data of a main routine or a subroutine immediately before processing branches is, for example, an address of a storage area, in the main memory 4, in which arguments of a function is stored.

In the example illustrated in FIG. 7, in a stack frame stored in the stack area when the CALL instruction for the function func-1 is executed, address (3), which is a return address, and addresses of storage areas (data storage areas) for values of the respective arguments x, y, z of the function func-1 in the main memory 4 are included.

When a stack frame is written to the storage area, in the stack area, indicated by the address of the stack pointer 12 after the update, an address designating the storage area for the stack frame is output from the stack pointer 12 to the bus IF unit 11. In this case, the address output from the stack pointer 12 (address of the stack pointer 12) is input to a control unit 54-1 of the arithmetic processing hardware 5-1 through the signal line 19C. The control unit 54-1 of the arithmetic processing hardware 5-1 holds the input address of the stack pointer in the control unit 54-1.

Upon execution of the CALL instruction for the function func-1 by the control unit 15 of the CPU 1, concurrently with storage of data before a branch to a subroutine such as the above, address (7) designated by the CALL instruction is output from the control unit 15 to the address translation unit 18. Upon input of address (7) to the address translation unit 18, as indicated in the address translation table in FIG. 6, address (11) is output from the address translation unit 18. Therefore, address (11) is set in the program counter 13.

Since address (11) is set in the program counter 13, address (11), that is, the arithmetic processing hardware 5-1 is called next to address (2).

In A3, since the function func-1 is called, the control unit 54-1 of the arithmetic processing hardware 5-1 performs processing as follows.

The control unit 54-1 reads the stack frame from the storage area, in the main memory 4, indicated by the address in the stack pointer 12 (FIG. 4, OP11). In the stack frame, the addresses of the data storage areas for the values of the arguments x, y, z, and the return address for RETURN are included. The return address for RETURN is address (3).

The control unit 54-1 reads the values of the arguments x, y, z of the function func-1 from the addresses of the data storage areas, which are included in the stack frame (FIG. 4, OP12), outputs the values to the arithmetic processing unit 53-1, and causes the arithmetic processing unit 53-1 to execute arithmetic processing for the function func-1 (FIG. 4, OP13). Until completion of the arithmetic processing for the function func-1, the control unit 54-1 returns a dummy JUMP instruction in response to a read from the CPU 1, so as to prevent the processing from returning to the main routine (FIG. 4, OP14 to OP16).

Upon end of the arithmetic processing in the arithmetic processing unit 53-1 (FIG. 4, OP14: YES), the control unit 54-1 writes an arithmetic operation result a of the arithmetic operation of the function func-1 to the function return value register 16R of the CPU 1 (FIG. 4, OP17). Also, if arguments are passed as a result of the arithmetic processing, the control unit 54-1 updates the data storage areas for the values of the arguments x, y, z in the main memory 4.

In A4, the control unit 54-1 returns a RETURN instruction in response to a read from the CPU 1 to return the processing to the main routine (FIG. 4, OP18).

Upon the RETURN instruction being read, the CPU 1 executes the following processing. The control unit 15 of the CPU 1 reads the stack frame from the address indicated by the stack pointer 12. Return destination address (3) acquired from the stack frame is output from the control unit 15 and input to the program counter 13 via the address translation unit 18. Consequently, next, codes are read from address (3), and the processing returns to the main routine. Also, the control unit 15 of the CPU 1 returns data other than the return destination address obtained from the stack frame to the respective original positions.

In A5, processing 2 is performed. In A6, a CALL instruction for calling the function func-2 is executed. Since arithmetic processing for the function func-2 is software processing, an address from which the function func-2 is called by the CPU 1 is still address (9) that is the storage area for the function func-2 in the main memory 4, and thus is not translated (see FIG. 6).

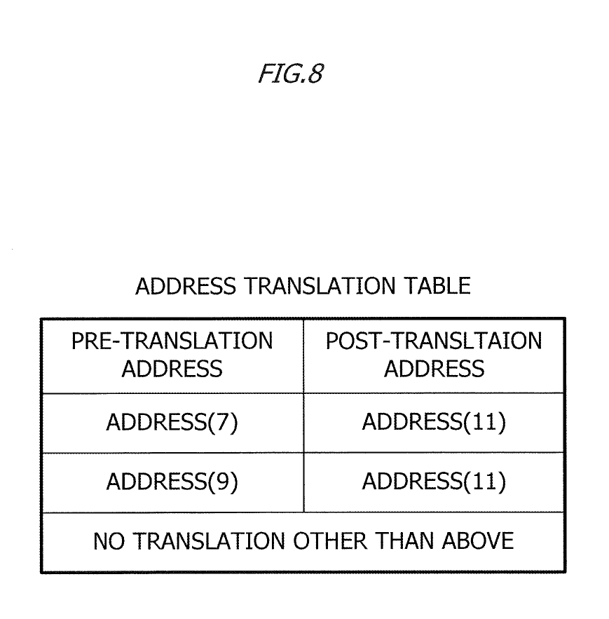

FIG. 8 is a diagram illustrating an example of an address translation table in specific example 2. In specific example 2, arithmetic processing for the function func-1 and the function func-2 is switched from software processing to hardware processing. Therefore, in the address translation table indicated in FIG. 8, address (7), in the main memory 4, in which function func-1 is stored, as a pre-translation address, and address (11) assigned to the arithmetic processing hardware 5, as a post-translation address, are associated with each other. Also, in the address translation table indicated in FIG. 8, address (9), in the main memory 4, in which the function func-2 is stored, as a pre-translation address, and address (11) assigned to the arithmetic processing hardware 5, as a post-translation address, are associated with each other.

Here, in reality, address (11) on the bus 6 is stored in the storage area, in the address memory 18M of the address translation unit 18, for the address, on the address memory 18M, associated with the address (7) on the bus 6. The address (11) on the bus 6 is stored in the storage area, in the address memory 18M of the address translation unit 18, for the address, on the address memory 18M, associated with address (9) on the bus 6.

In specific example 2, program A is an example of “a first instruction group”. In specific example 2, each of the bodies (code groups) of the function func-1 and the function func-2 in the main memory 4 is an example of “a second instruction group”. In specific example 2, each of addresses of storage areas for the bodies of the function func-1 and the function func-2 in the main memory 4 is an example of “an address used for execution of the second instruction group”. In the specific example 2, the address of the arithmetic processing hardware 5 is an example of “an address assigned to the circuit”.

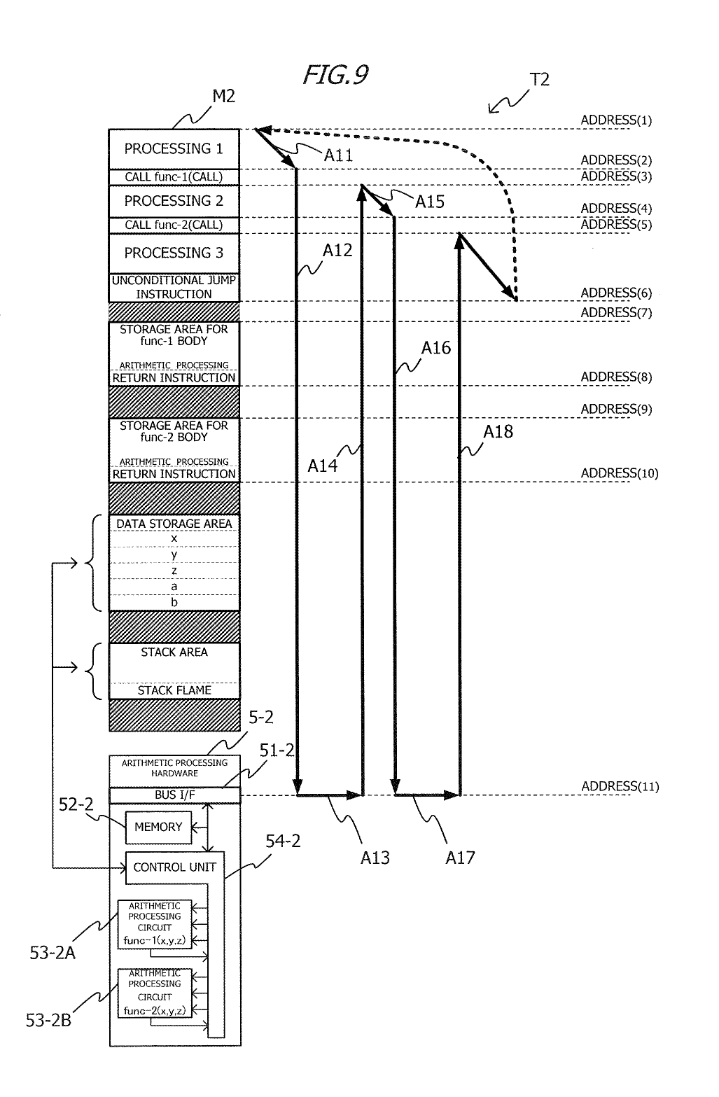

FIG. 9 is a diagram illustrating an example of execution image T2 of program A according to specific example 2. Also, in FIG. 9, storage image M2 of a program in the main memory 4 and a block diagram of arithmetic processing hardware 5-2 are illustrated. The arithmetic processing hardware illustrated in FIG. 9 is indicated from a functional perspective. In specific example 2, also, there is no change in main routine of program A, and thus, the storage image M2 of a program in the main memory 4, which is illustrated in FIG. 9, is the same as the storage image M1 of a program in the main memory 4, which is illustrated in FIG. 7.

The arithmetic processing hardware 5-2 according to specific example 2 includes an arithmetic processing unit 53-2A, which is an arithmetic processing circuit for the function func-1, and an arithmetic processing unit 53-2B, which is an arithmetic processing circuit for the function func-2.

In specific example 2, arithmetic processing for the function func-1 and the function func-2 is hardware processing. Therefore, processing in A11 to A15 is similar to the processing in A1 to A5 in FIG. 7. Also, in processing in A16 to A18, processing that is similar to the processing in A2 to A4 in FIG. 7 is performed as the arithmetic processing for the function func-2.

In other words, upon the function func-2 being called in response to a CALL instruction, address (9) designated by the CALL instruction is translated into address (11) assigned to the arithmetic processing hardware 5-2, by the address translation unit 18 of the CPU 1. Consequently, upon the function func-2 being called in response to the CALL instruction, the arithmetic processing hardware 5-2 is called (A16).

A control unit 54-2 of the arithmetic processing hardware 5-2 acquires an address of a storage area for a stack frame from the stack pointer 12 and acquires return destination address (5) and addresses of storage areas for values of the arguments x, y, z, b, from the stack frame. The control unit 54-2 acquires the values of the arguments x, y, z, b from the main memory 4, outputs the values to the arithmetic processing unit 53-2B and causes the arithmetic processing unit 53-2B to execute arithmetic processing for the function func-2. Until completion of the arithmetic processing, the control unit 54-2 returns, e.g., a JUMP instruction designating an address assigned to the arithmetic processing unit 53-2B, in response to a read from the CPU (A17).

Upon completion of the arithmetic processing, the control unit 54-2 writes “success”, which is a result of the processing for the function func-2, to the function return value register 16R. Also, since the function func-2 uses the result of the arithmetic operation as the argument b, the control unit 54-2 writes the result of the arithmetic operation to the storage area for the value of the argument b in the main memory 4. Subsequently, upon the control unit 54-2 returning a RETURN instruction to the CPU 1, the processing returns to the main routine (A18). A return destination address in the RETURN instruction is address (5).

In each of specific example 1 and specific example 2, an address for calling the function func-1 or the function func-2 is translated into the address of the arithmetic processing hardware 5 by the address translation unit 18 (address translation table). Also, in each of specific example 1 and specific example 2, the main routine of program A is the same, that is, there is no change in main routine of program A.

### Operation and Effects of First Embodiment

In the first embodiment, the address translation unit 18 is included in the CPU 1. The address translation unit 18 includes the address memory 18M that holds a post-translation address associated with a pre-translation address. In the first embodiment, as the pre-translation address, an address of a storage area for a body of a subroutine in the main memory 4, the address being used for calling the subroutine, is used. As the post-translation address, the address of the arithmetic processing hardware 5 that performs arithmetic processing for the subroutine is used. If the address of the storage area, in the main memory 4, in which a body of the subroutine is stored is input as a result of execution of a branch instruction such as a CALL instruction or a JUMP instruction to the address translation unit 18 from the control unit 15, the address of the arithmetic processing hardware 5 is output from the address translation unit 18 to the program counter 13. Consequently, software processing can be replaced by hardware processing with no software execution code change.

According to the first embodiment, software processing can be replaced by hardware processing with no change in codes for execution of a main routine, the need for, e.g., stoppage of a main routine and re-start of the information processing apparatus 100 accompanying a change in the main routine can be eliminated. Also, in arithmetic processing that consumes less power when the arithmetic processing is performed as hardware processing, than when the arithmetic processing is performed as software processing, replacement of software processing by hardware processing enables reduction in power consumption.

Also, in the first embodiment, the arithmetic processing hardware 5 is connected to the stack pointer 12 via a signal line. Also, in order to enable the arithmetic processing hardware 5 to get read/write access to the main memory 4, the main memory 4 is made to be a dual-port memory or time-division access via the bus 6 is set. Consequently, the arithmetic processing hardware 5 can acquire an address of a storage area for a stack frame in the main memory 4 from the stack pointer 12, and thus can acquire, e.g., data to be used for arithmetic processing for a subroutine, not via a main routine. According to the above, also, software processing can be replaced by hardware processing with no change in main routine.

Also, in the first embodiment, the arithmetic processing hardware 5 is connected to the function return value register 16R in the CPU 1 via a signal line. Accordingly, the arithmetic processing hardware 5 can write a result of an arithmetic operation directly to the function return value register 16R. In the function return value register 16R, a return value of a subroutine is written also where the subroutine is subjected to software processing. Therefore, as a result of the arithmetic processing hardware 5 writing a result of an arithmetic operation directly to the function return value register 16R, the function return value register can be brought into a state that is the same as a state where software processing returns from a subroutine to a main routine. Accordingly, even if a subroutine is replaced by processing in the arithmetic processing hardware 5 relative to a main routine, the subroutine can be made to appear as software processing.

Also, in the first embodiment, if a predetermined condition is met, the control unit 54 of the arithmetic processing hardware 5 rewrites a post-translation address stored in the address memory 18M of the address translation unit 18 to the address of the arithmetic processing hardware 5 or an address of a storage area of the main memory 4. The address translation unit 18 corresponds to an address translation table. The predetermined condition is determined according to environmental conditions such as a temperature and/or a load status of the CPU 1. Therefore, according to the first embodiment, processing for a subroutine can be switched to hardware processing or software processing according to an environmental status. Furthermore, in the first embodiment, switching of processing for a subroutine between hardware processing and software processing can be performed without rewriting a main routine, that is, without stoppage of processing for the main routine and re-start of the information processing apparatus 100.

Here, the processing for rewriting the address translation table (FIG. 3) is not necessarily performed by the control unit 54 of the arithmetic processing hardware 5. For example, it is possible that: a program including the processing content indicated in FIG. 3 is provided or a program including codes for rewriting the address translation table is included in a program; and the CPU 1 is made to execute the program to cause the CPU 1 itself to perform address translation processing.

Also, if a predetermined address range is assigned to the arithmetic processing hardware 5, addresses may be made to correspond to the respective arithmetic processing circuits. For example, in specific example 2, in the first embodiment, if the function func-1 and the function func-2 are called, the same address assigned to the arithmetic processing hardware 5-2 is used. Instead of this, for example, different addresses may be called for the function func-1 and the function func-2 within the address range assigned to the arithmetic processing hardware 5-2.

### COMPARATIVE EXAMPLE

As a comparative example, replacement of software processing with hardware processing in an information processing apparatus including no address translation unit 18 will be described.

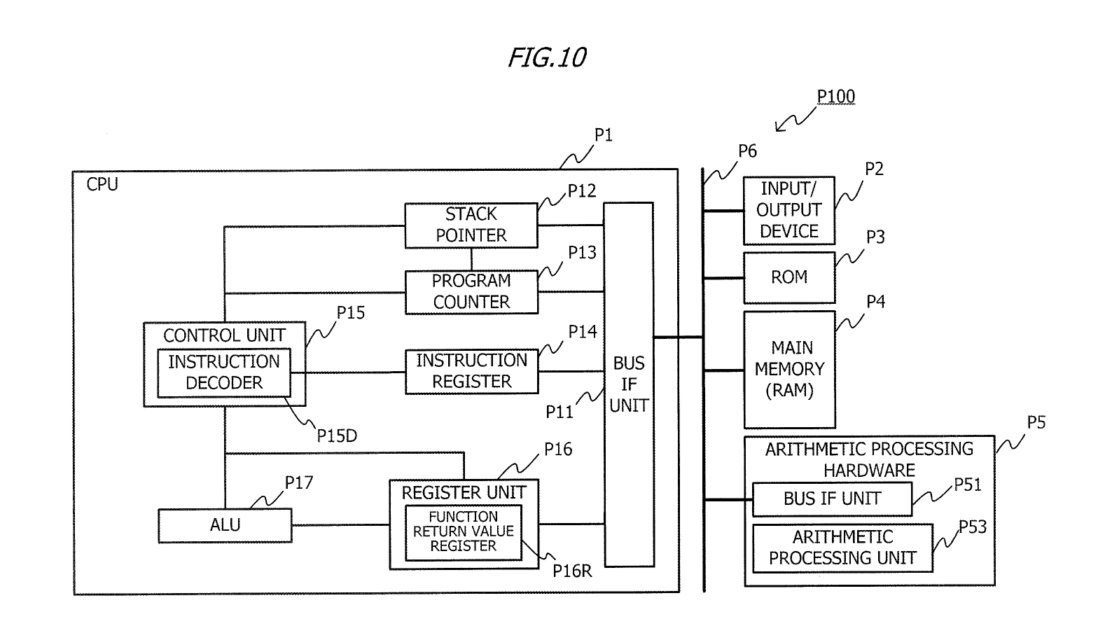

FIG. 10 is a diagram illustrating an example of a hardware configuration of an information processing apparatus. An information processing apparatus P100 according to a comparative example includes a CPU P1, an input/output device P2, a ROM P3, a main memory P4 and an arithmetic processing hardware P5.

The information processing apparatus P100 is different from the information processing apparatus 100 according to the first embodiment in that the CPU P1 includes no address translation unit and the arithmetic processing hardware P5 includes no control unit. Also, each of the stack pointer P12 and function return value register P16R is not connected to the arithmetic processing hardware P5.

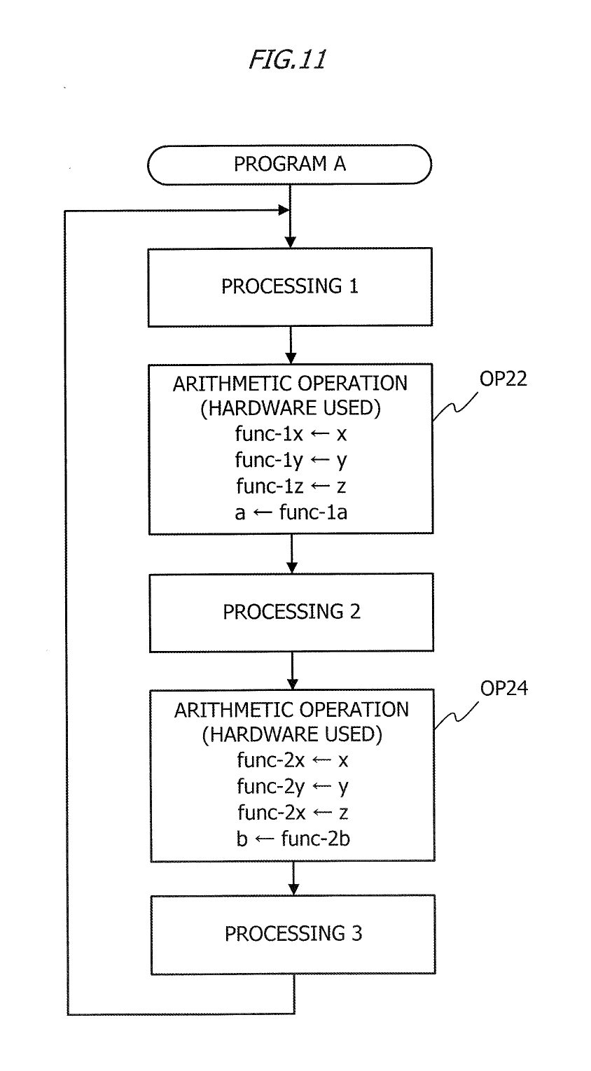

FIG. 11 is an example of a flowchart of a main routine of program A according to the comparative example. The flowchart illustrated in FIG. 11 is a flowchart of a program that is the same as program A according to the first embodiment. In the comparative example, arithmetic processing for a function func-1 and a function func-2 is executed by the arithmetic processing hardware P5. Therefore, the flowchart of the main routine of program A illustrated in FIG. 11 is also one provided on the assumption that arithmetic processing for the function func-1 and the function func-2 is executed by the arithmetic processing hardware P5.

In order to pass arguments to be used for arithmetic processing for the function func-1 and the function func-2 to the arithmetic processing hardware P5, in OP22 and OP24 in the flowchart illustrated in FIG. 11, processing for writing arguments to registers in the arithmetic processing hardware P5 is added. The processing for writing arguments to the registers in the arithmetic processing hardware P5 is indicated by “func-1x←x”, “func-1y←y”, “func-1z←z”, “func-2x←x”, “func-2y←y” and “func-2z←z” in FIG. 11. The indications “func-1x”, “func-1y”, “func-1z”, “func-2x”, “func-2y” and “func-2z” in FIG. 11 denote registers in the arithmetic processing hardware P5, the registers storing respective values of arguments x, y, z of the function func-1 and the function func-2.

The “a←func-1a” in OP22 and the “b←func-2b” in OP24 indicate that results of arithmetic operations of the functions func-1, func-2 are assigned to variables a, b, respectively. The “func-1a” and the “func-2b” denote sites for storing values of results of arithmetic operations of the functions func-1, func-2, respectively. The sites for storing values of results of arithmetic operations of the functions func-1, func-2, respectively, are the registers in the arithmetic processing hardware P5. Therefore, in OP22 and OP24, processing for reading results of arithmetic operations of the functions func-1, func-2, from the registers in the arithmetic processing hardware P5 is added, respectively.

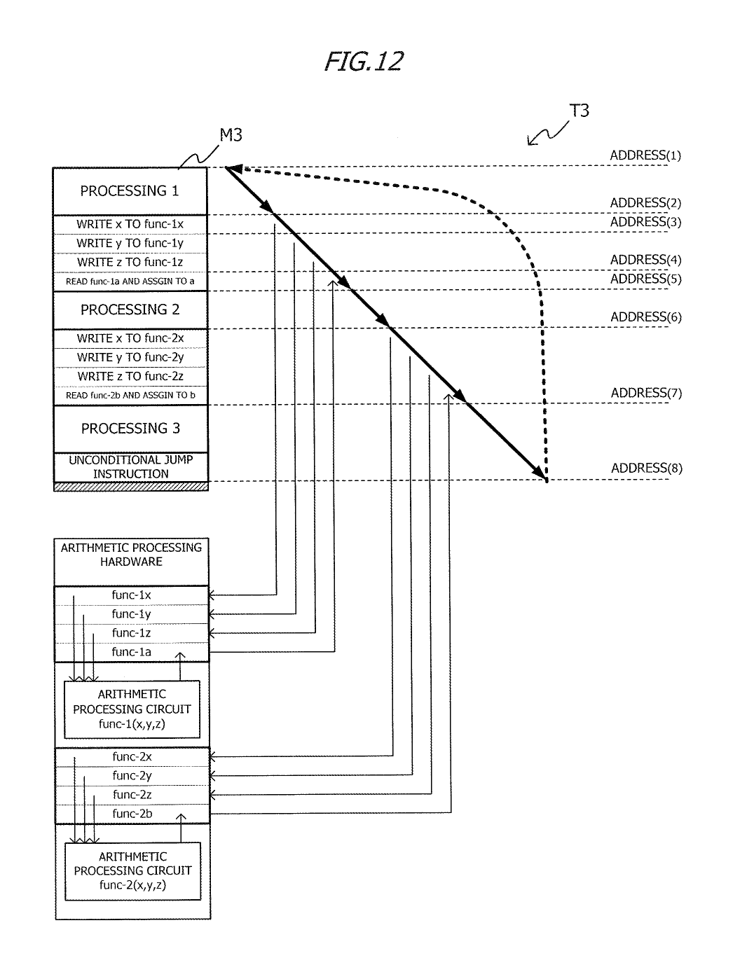

FIG. 12 is a diagram illustrating an example of an execution image T3 of program A according to the comparative example. Also, in FIG. 12, a storage image M3 of a program in the main memory P4 and a block diagram of the arithmetic processing hardware P5 are illustrated.

In FIG. 12, codes of a main routine of program A are stored in an address range of addresses (1) to (8). Also, in FIG. 12, execution codes for arithmetic processing for the function func-1 in OP22 in the flowchart illustrated in FIG. 11 are stored at addresses (2) to (4). In FIG. 12, execution codes for arithmetic processing for function func-2 in OP24 in the flowchart illustrated in FIG. 11 are stored at address (6).

In the arithmetic processing hardware P5, the registers and respective arithmetic circuits for the function func-1 and the function func-2 are included.

In the comparative example, codes are read and executed in order from address (1) in the main memory P4 (see a program execution image T3). For arithmetic processing for the function func-1 and the function func-2, also, no codes are read from addresses outside the address range in which the main routine is stored.

In the comparative example, the CPU P1 includes no address translation unit 18, and thus, where software processing is replaced by hardware processing, as in the example illustrated in FIG. 11, the main routine is changed. Thus, processing is not flexibly switched between software processing and hardware processing according to an environmental condition.

### Example Applications of Information Processing Apparatus According to First Embodiment

One of example applications of the information processing apparatus 100 according to the first embodiment is a transmission apparatus on an optical network.

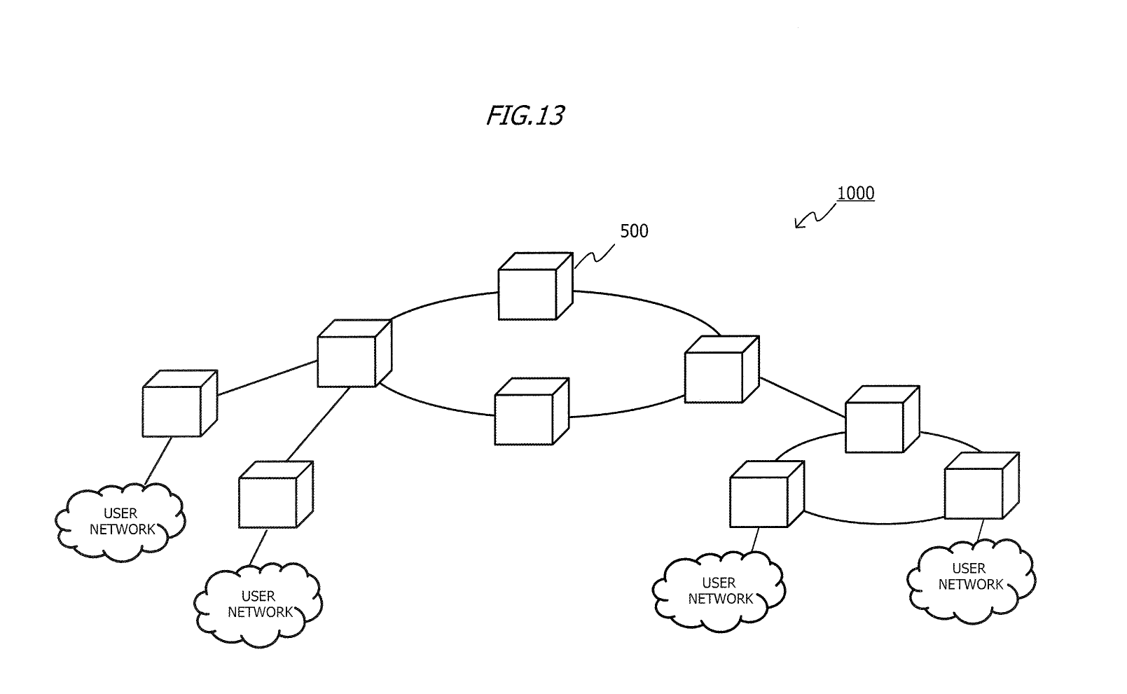

FIG. 13 is a diagram illustrating an example of a system configuration of an optical network system. An optical network system 1000 includes a plurality of transmission apparatuses 500 to which the information processing apparatus 100 according to the first embodiment is applied. Optical signals are transmitted among the transmission apparatuses 500 with optical fibers as mediums. Each transmission apparatus 500 is connected to other transmission apparatuses 500 or a user network.

For example, a transmission apparatus 500 connected to a user network includes an interface with user terminals and an interface with the other transmission apparatuses 500. The interface with the other transmission apparatuses 500 conforms to higher-speed standards compared to those of the interface with user terminals.

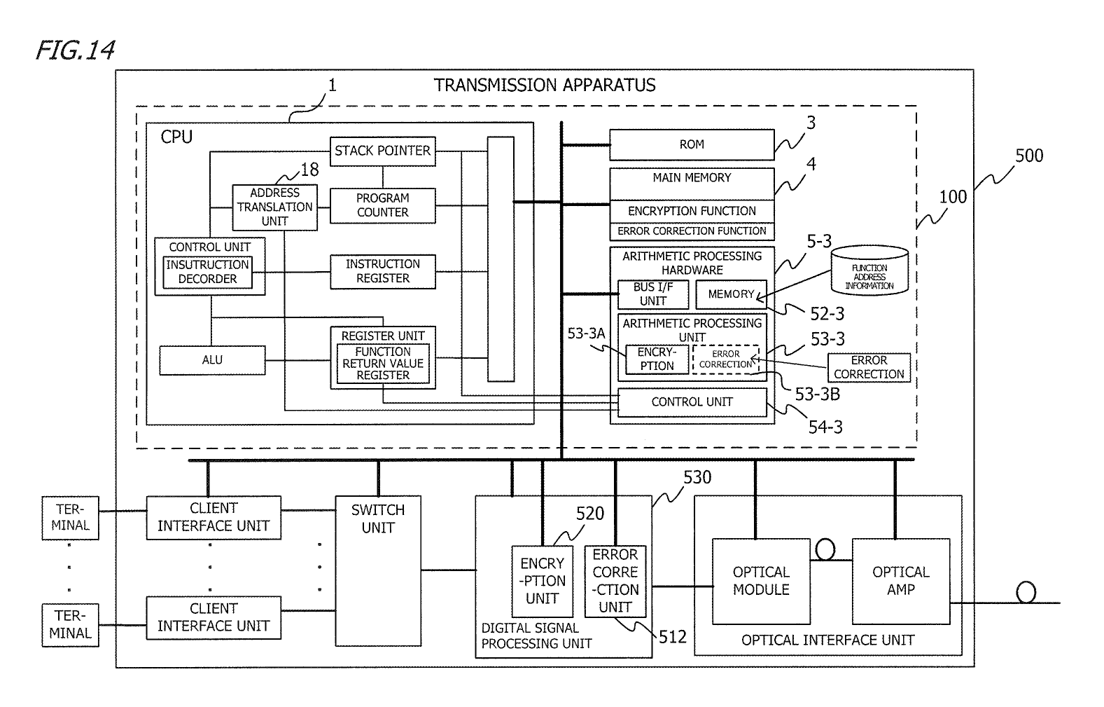

FIG. 14 is an example of a block diagram of a transmission apparatus, which is an example application of the information processing apparatus according to the first embodiment. The transmission apparatus 500 includes a client interface unit, a switch unit, a digital signal processing unit 510 and an optical interface unit, in addition to the configuration of the information processing apparatus 100 according to the first embodiment.

The digital signal processing unit 510 includes an encryption unit 520 and an error correction unit 530. A CPU 1 writes results of arithmetic operations in arithmetic processing for encryption and arithmetic processing for error correction to the digital signal processing unit 510, whereby functions of the encryption unit 520 and the error correction unit 530 are provided.

Arithmetic processing hardware 5-3 includes an arithmetic processing circuit 53-3A for encryption, and arithmetic processing for encryption is performed by the arithmetic processing hardware 5-3. Arithmetic processing for error correction is performed by the CPU 1 (software processing).

For example, it is assumed that in the transmission apparatus 500, error correction processing is switched to hardware processing. In this case, an arithmetic circuit 53-3B for error correction is added to the arithmetic processing hardware 5-3. Triggered by this, a control unit 54-3 in the arithmetic processing hardware 5-3 executes address translation table rewrite processing.

More specifically, for example, the control unit 54-3 in the arithmetic processing hardware 5-3 executes the processing in FIG. 3 to rewrite an address translation table. In this case, the predetermined condition in OP 1 in FIG. 3 is, for example, detection of addition of a new arithmetic circuit. Also, with the addition of the arithmetic circuit 53-3B for error correction, function address information stored in the memory 52-3 is updated by addition of an address of a storage area for a code group of a subroutine for error correction in a main memory 4. Based on the updated function address information, the control unit 54-3 writes an address of the arithmetic processing hardware 5-3 in an area in an address memory 18M, the area corresponding to an address in the address memory 18M, the address being associated with the address of the storage area for the code group of the subroutine for error correction processing in the main memory 4.

After completion of rewrite of a post-translation address for arithmetic processing for error correction in the address translation table to the address of the arithmetic processing hardware 5-3, upon arithmetic processing for error correction being called, the arithmetic processing for error correction is executed by the arithmetic circuit 53-3B for error correction. The arithmetic processing for error correction can be switched from software processing to hardware processing without the CPU 1 changing, stopping or restarting a main routine in execution. Since the transmission apparatus 500 handles communication data, instantaneous interruption of communication due to switching from software processing to hardware processing can be suppressed. Employment of the arithmetic processing hardware 5-3 that consumes less power and switching of arithmetic processing for error correction to processing in the arithmetic processing hardware 5-3 enable power consumption reduction.

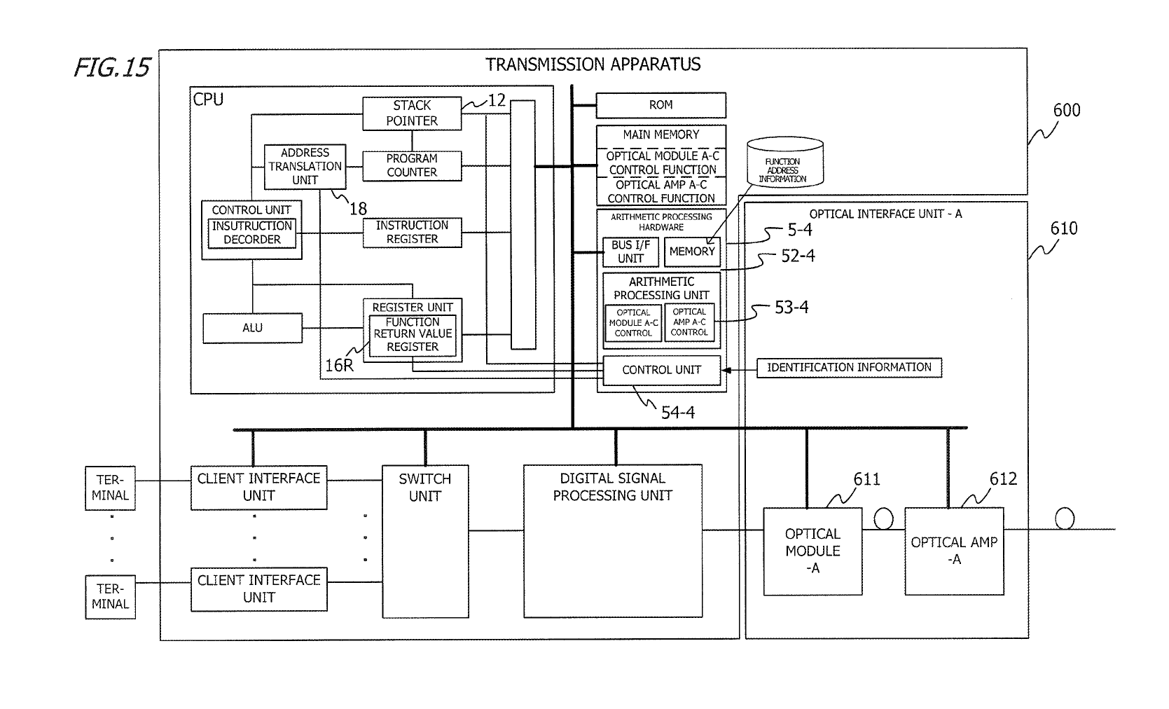

FIG. 15 is an example of a block diagram of a transmission apparatus, which is another example application of the information processing apparatus according to the first embodiment. In a transmission apparatus 600 in FIG. 15, an optical interface unit 610 is detachable and the optical interface unit 610 is thus replaceable. The optical interface unit 610 includes modules such as an optical module unit 611 and an optical amplifier (AMP) unit 612.

Characteristics of the optical module unit 611 and the optical AMP unit 612 are adjusted according to environmental conditions such as a temperature, a load status of a CPU 1, a type of data and/or a flow rate of data. Arithmetic processing hardware 5-4 includes a control circuit for adjusting the characteristics of the optical module unit 611 and the optical AMP unit 612.

In the transmission apparatus 600, arithmetic processing relating to control of the optical module unit 611 and the optical AMP unit 612 is switched between software processing and hardware processing according to the environmental conditions such as a temperature, a load status of the CPU 1, a type of data and/or a flow rate of data.

For example, in the arithmetic processing hardware 5-4 includes arithmetic processing circuits for control functions for different optical devices, which are optical modules A to C and optical AMPs A to C included in optical interface units A to C, respectively. Also, in a main memory 4, code groups for control functions for different optical devices, which are the optical modules A to C and the optical AMPs A to C included in the optical interface units A to C, respectively, are stored.

The CPU 1 and a control unit 54-4 each detect attachment of an optical interface unit 610, and use relevant control functions based on identification information of the optical interface unit 610. For example, in a main routine, there is no distinction among the control functions of the optical module units A to C, and when any of the control functions for the optical module units A to C is read, a representative address indicating a control function of an optical module unit is used. Likewise, in the main routine, there is also no distinction in control function among the optical AMP units A to C, and when a control function of an optical AMP unit is read, a representative address indicating a control function of an optical AMP unit is used. Which of the control functions of the optical modules A to C and which of the control functions of the optical AMPs A to C to be used are selected by the control unit 54-4 based on identification information of an attached optical interface unit. As pre-translation addresses in an address translation table, the representative addresses of control functions of an optical module unit and an optical AMP unit are used, and as post-translation addresses, addresses of storage areas for the control functions selected by the control unit 54-4 in the main memory 4 or an address of the arithmetic processing hardware 5-4 are written. Details will be described later. Or, for example, processing for discriminating identification information of an optical interface unit 610 may be included in the main routine so as to branch into processing for a relevant one of the optical module unit A to C and a relevant one of the optical AMP unit A to C according to the identification information, to use relevant control functions.

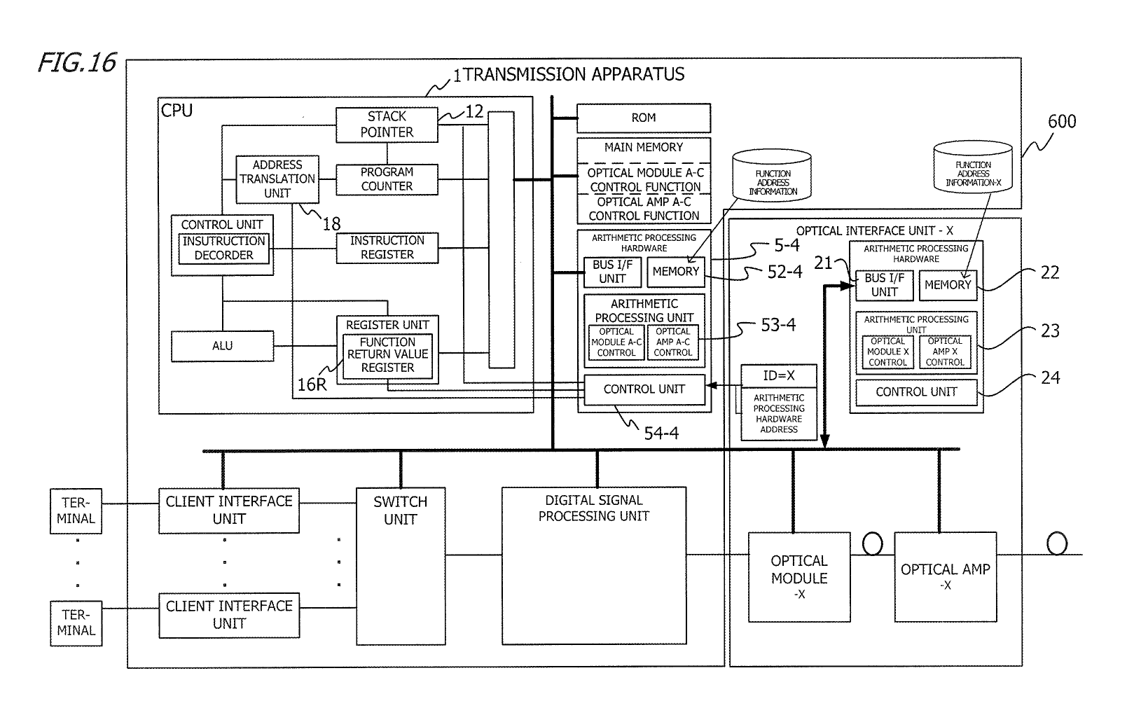

FIG. 16 is an example of a block diagram of a transmission apparatus, which is another example application of the information processing apparatus according to the first embodiment. FIG. 16 indicates a case where an optical interface unit X, control functions of which are not provided as software or hardware in a transmission apparatus 600, is attached to the transmission apparatus 600 illustrated in FIG. 15. In this case, in the optical interface unit X that is unknown to the transmission apparatus 600, arithmetic processing hardware X for performing arithmetic processing for control functions for an optical module X and an optical AMP X mounted in the optical interface unit X is provided.

The arithmetic processing hardware X is, for example, an FPGA. The arithmetic processing hardware X includes a bus IF unit 21, a memory 22, an arithmetic processing unit 23 and a control unit 24. The arithmetic processing unit 23 includes respective arithmetic circuits for performing arithmetic processing for the control functions for the optical module X and the optical AMP X. In the memory 22, function address information is stored. In the function address information in the memory 22, for example, representative addresses to be used for a main routine to call respective control functions of an optical module unit and an optical AMP unit are stored as pre-translation addresses.

The control unit 24 in the arithmetic processing hardware X, for example, accesses the arithmetic processing hardware 5-4 through the bus IF unit 21. The control unit 24 in the arithmetic processing hardware X, for example, reads a latest value of a stack pointer 12 held by the control unit 54-4 to acquire the value of the stack pointer 12. Also, the control unit 24 in the arithmetic processing hardware X, for example, passes a value to be written to a function return value register 16R to the control unit 54-4 to cause the control unit 54-4 to write results of arithmetic processing to the function return value register 16R instead of the control unit 24. However, the present invention is not limited to this example, the arithmetic processing hardware X may be connected to the stack pointer 12 and the function return value register 16R via respective signal lines so as to acquire the value of the stack pointer 12 or write an arithmetic operation result to the function return value register 16R, through the relevant signal line.

When the optical interface unit X is attached to the transmission apparatus 600, the arithmetic processing hardware 5-4 rewrites an address translation table in the CPU 1 so that addresses for the CPU 1 to call control functions for an optical module unit and an optical AMP unit are arithmetic processing hardware X.

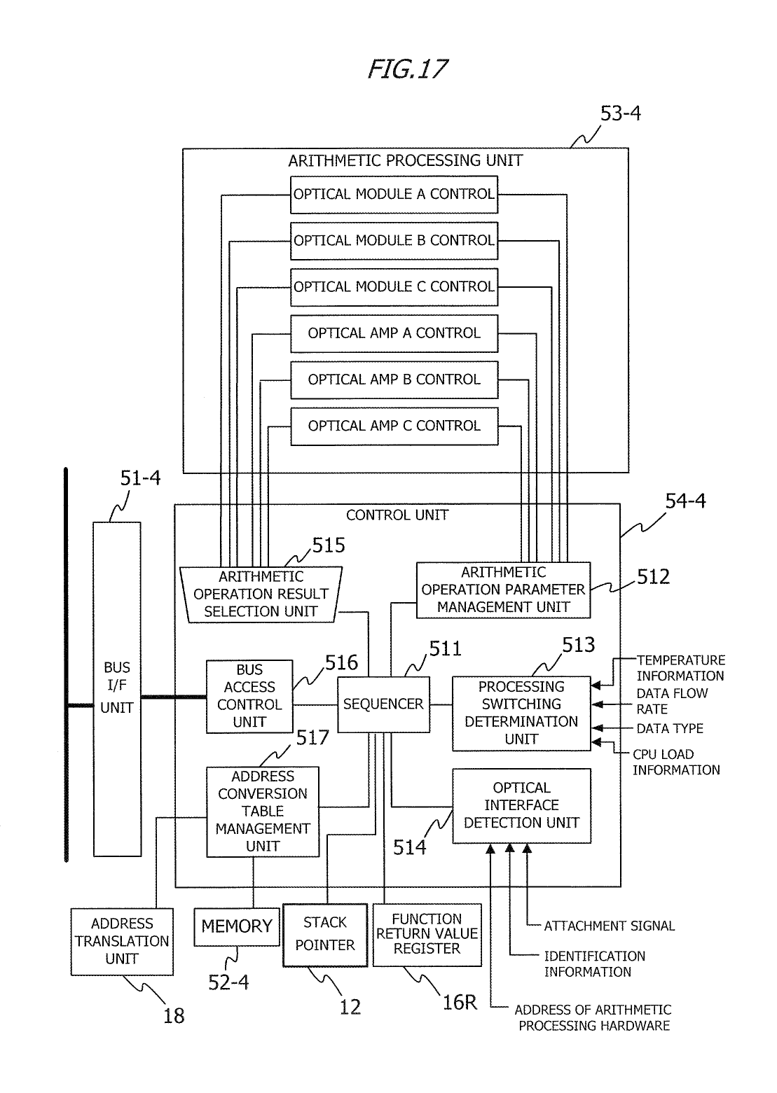

FIG. 17 is an example of a block diagram of a control unit included in arithmetic processing hardware in a transmission apparatus. A control unit 54-4 includes a sequencer 511, an arithmetic operation parameter management unit 512, a switching determination unit 513, an optical interface detection unit 514, an arithmetic operation result selection unit 515, a bus access control unit 516 and a table management unit 517. Each of these components is a circuit programmed so as to execute predetermined processing.

The arithmetic operation parameter management unit 512 receives arguments to be used for arithmetic operations performed in the arithmetic processing unit 53-4 from the sequencer 511 and outputs the arguments to the relevant arithmetic circuits.

The switching determination unit 513 determines switching of arithmetic processing between software processing and hardware processing. For example, information such as temperature information, CPU load information, a data type and/or a data flow rate are input to the switching determination unit 513 from other hardware components included in a transmission apparatus 600. The switching determination unit 513 determines whether or not a hardware switching condition is met, based on the input information. If the hardware switching condition is met, it is determined to switch processing from software processing to hardware processing. For the hardware switching condition, different conditions may be set in advance for the optical modules A to C and the optical AMPs A to C or a common condition may be set. A result of the hardware switching condition determination is output to the sequencer 511.

The optical interface detection unit 514 detects attachment or detachment of an optical interface unit 610. Upon attachment of the optical interface unit 610, an attachment signal and identification information, and if arithmetic processing hardware is mounted in the optical interface unit 610, an address of the arithmetic processing hardware are input from the attached optical interface unit 610 to the optical interface detection unit 514. The optical interface detection unit 514 detects the attachment of the optical interface unit 610 via the input of the attachment signal and outputs the identification information and the address of the arithmetic processing hardware input from the attached optical interface unit 610, to the sequencer 511.

The attachment signal from the optical interface unit 610 is input to the optical interface unit 514 in a predetermined period. If the optical interface detection unit 514 detects that the attachment signal from the optical interface unit 610 is not input for a predetermined period of time, the optical interface detection unit 514 detects detachment of the optical interface unit 610 and notifies the sequencer 511 of the detachment.

The arithmetic operation result selection unit 515 is a selector that performs path switching between arithmetic circuits for respective control functions for the optical modules A to C and the optical AMPs A to C, which are included in the arithmetic processing unit 53-4, and the sequencer 511. Identification information of an attached optical interface is input from the sequencer 511 to the arithmetic operation result selection unit 515. The arithmetic operation result selection unit 515 sets paths so that the arithmetic circuits for the respective control functions for an optical module and an optical AMP according to the input identification information and the sequencer 511 are connected. Upon input of an arithmetic operation result from the arithmetic circuit for the control function of the optical module or the optical AMP to the arithmetic operation result selection unit 515, the arithmetic operation result is output to the sequencer 511.

The bus access control unit 516 is an interface between the bus IF unit 51-4 and the control unit 54-4. Through the bus access control unit 516, for example, calling of control functions of an optical module and an optical AMP and reading of arguments are performed.

The table management unit 517 rewrites an address translation table. In reality, the table management unit 517 is connected to an address memory 18M in an address translation unit 18 in a CPU 1 and rewrites the address memory 18M.

If any of known optical interface units A to C is attached to the transmission apparatus 600, an instruction signal for table rewriting is input from the sequencer 511 to the table management unit 517. Upon input of the instruction signal from the sequencer 511, the table management unit 517 acquires pre-translation addresses used for control function calling, from function address information stored in a memory 52-4. The table management unit 517 rewrites post-translation addresses associated with the acquired pre-translation addresses in the address translation table to an address of the arithmetic processing hardware 5-4.

If it is detected that an unknown optical interface unit X is attached to the transmission apparatus 600, an instruction signal for table rewriting and an address of arithmetic processing hardware X included in the optical interface unit X are input from the sequencer 511 to the table management unit 517. Upon input of the instruction signal from the sequencer 511, the table management unit 517 acquires pre-translation addresses used for control function calling from the function address information stored in the memory 52-4. The table management unit 517 rewrites post-translation addresses associated with the acquired pre-translation addresses in the address translation table to an address of the arithmetic processing hardware X.

The sequencer 511 controls input/output to/from the respective circuits in a manner programmed in advance. For example, processing in the sequencer 511 when a control function for an arithmetic circuit included in the arithmetic processing unit 53-4 is called is as follows.

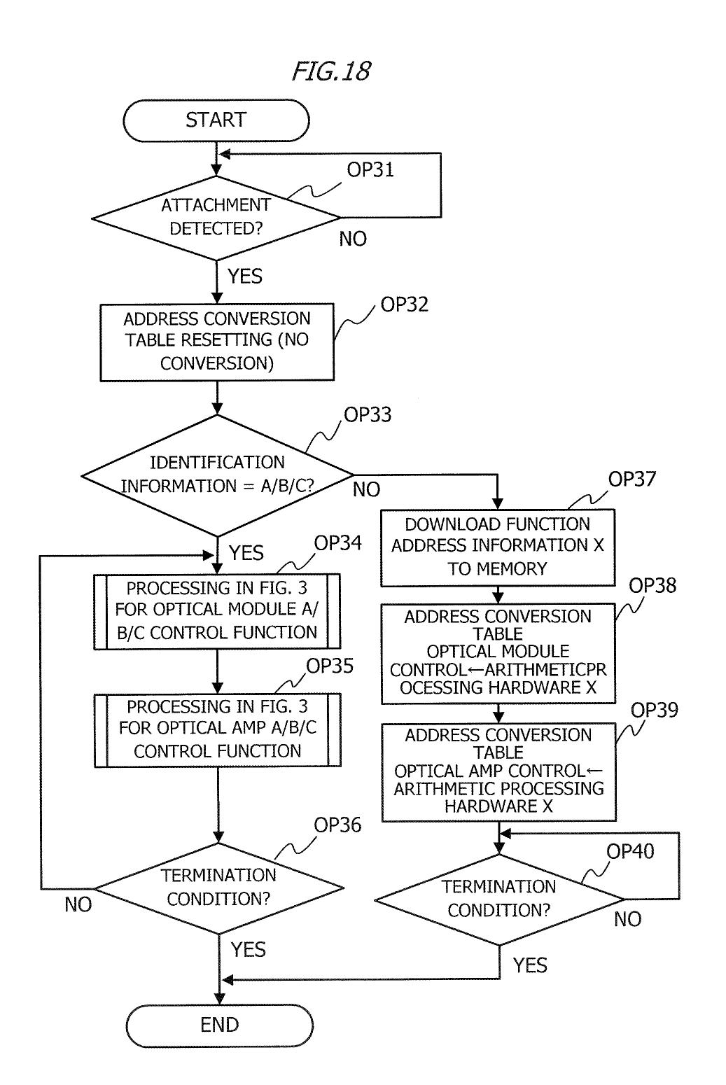

The sequencer 511 acquires an address of a stack frame output from a stack pointer 12 through a signal line. The sequencer 511 reads the stack frame from the address output from the stack pointer 12 and acquires values of arguments of the control function. The acquired values of the arguments of the control function are output from the sequencer 511 to the arithmetic operation parameter management unit 512. Until an arithmetic operation result is input from the arithmetic operation result selection unit 515 to the sequencer 511, the sequencer 511, for example, returns a dummy instruction such as a JUMP instruction designating an address assigned to the arithmetic processing unit 53-4 to the CPU 1 through the bus access control unit 516. If an arithmetic operation result is input from the arithmetic operation result selection unit 515 to the sequencer 511, the arithmetic operation result is written from the sequencer 511 to a function return value register 16R in the CPU 1. For example, if an arithmetic operation result is an argument of a function, the sequencer 511 writes the argument of the function to a data storage area in a main memory 4 through the bus access control unit 516. Details of processing relating to address table write processing in the sequencer 511 will be described later with reference to FIG. 18.

FIG. 18 is an example of a flowchart of address table rewrite processing in the control unit 54-4 of the arithmetic processing hardware 5-4. The processing illustrated in FIG. 18 is repeatedly executed during operation of the transmission apparatus 600.

In OP31, the control unit 54-4 determines whether or not attachment of an optical interface unit 610 is detected. If attachment of an optical interface unit 610 is detected (OP31: YES), the processing proceeds to OP32. If attachment of an optical interface unit 610 is not detected (OP31: NO), a standby state continues until attachment of an optical interface unit 610 is detected. In the processing in OP31, an attachment signal is input to the optical interface detection unit 514, and identification information of the attached optical interface unit 610 from the optical interface detection unit 514 is input to the sequencer 511.

In OP32, the control unit 54-4 resets the address translation table so as to prevent translation of addresses to be called by a main routine for all functions in the address translation table. For example, the address translation table can be reset by rewriting post-translation addresses stored in the address memory 18M to pre-translation addresses associated with the respective addresses stored in the address memory 18M. In the processing in OP32, the sequencer 511 notified of the detection of the attachment of the optical interface unit 610 provides an instruction for resetting the address translation table to the table management unit 517 and the table management unit 517 updates the address memory 18M.

In OP33, the control unit 54-4 determines whether or not the identification information of the optical interface unit 610 is that of any of the optical interface units A to C. If the optical interface unit 610 is any of the optical interface units A to C (OP33: YES), the processing proceeds to OP34. If the optical interface unit 610 is none of the optical interface units A to C (OP33: NO), the processing proceeds to OP37. In the processing in OP33, the sequencer 511 performs the determination based on the input identification information.

In OP34, for arithmetic processing for a control function for an optical module unit corresponding to the identification information of the attached optical interface unit 610 from among the optical module units A/B/C, the processing illustrated in FIG. 3 is executed. In OP35, for arithmetic processing of a control function for an optical AMP unit corresponding to the identification information of the attached optical interface unit 610 from among the optical AMP units A/B/C, the processing illustrated in FIG. 3 is executed. More specifically, if the hardware switching condition is met, post-translation addresses associated with representative addresses of control functions for an optical module unit or an optical AMP unit are rewritten to the address of the arithmetic processing hardware 5-4 in the address translation table. If the hardware switching condition is not met, a post-translation address of the control function of the relevant optical module unit or optical AMP unit is rewritten to the address of the arithmetic processing hardware 5-4 in the address translation table.

In processing in OP34 and OP35, a result of hardware switching condition determination for the control function of the relevant optical module unit or optical AMP unit is input from the unit processing switching determination unit 153 to the sequencer 511. If the result of the hardware switching condition determination has a change, an address translation table rewrite instruction signal is output from the sequencer 511 to the table management unit 517 (FIG. 3, OP2: NO, OP4: NO). The table management unit 517 rewrites a post-translation address to the address of the arithmetic processing hardware 5-4 or a representative address to be used by a main routine for a control function of an optical module unit or an optical AMP unit in the address translation table (FIG. 3, OP3, OP5). Which address to be rewritten is determined, for example, based on a flag indicating whether hardware processing or software processing is currently being performed. After the processing in OP35, the processing proceeds to OP36.

In OP36, the control unit 54-4 determines whether or not a termination condition is met. The termination condition is, for example, detection of detachment of the optical interface unit A/B/C. If the termination condition is met (OP36: YES), the processing illustrated in FIG. 18 ends. If the termination condition is not met (OP36: NO), the processing proceeds to OP34.

In OP37, the control unit 54-4 downloads the function address information X from the optical interface unit X to the memory 52-4. In the processing in OP37, the sequencer 511 reads the function address information X from the optical interface unit X via the bus access control unit 516 and writes the function address information X to the memory 52-4. In the function address information X from the optical interface unit X, representative addresses of functions for arithmetic circuits included in the optical interface unit X (addresses to be used when such functions are called by the main routine) are stored. For example, the function address information X is stored in the memory 52-4 together with the identification information of the optical interface unit X.

In OP38 and OP39, the control unit 54-4 rewrites a post-translation address, in the address translation table, corresponding to the representative address of the control function for the optical module unit X or the optical AMP unit X to the address of the arithmetic processing hardware X. In the processing in OP37, an address translation table rewrite instruction signal, and the identification information and the address of the arithmetic processing hardware X are output from the sequencer 511 to the table management unit 517. The table management unit 517 rewrites a post-translation address stored as an address of the address memory 18M, the address being associated with the representative address of the control function for the optical module unit X or the optical AMP unit X included in the function address information X in the memory 52-4, to the address of the arithmetic processing hardware X. After the processing in OP39, the processing proceeds to OP40.

In OP40, the control unit 54-4 determines whether or not a termination condition is met. The termination condition is, for example, detection of detachment of the optical interface unit X. If the termination condition is met (OP40: YES), the processing illustrated in FIG. 18 ends.

In the case of each of the example applications in FIGS. 15 to 18, for each of the optical interface units A to C, arithmetic processing for the control functions for the optical module unit and the optical AMP unit can be switched between software processing and hardware processing without rewriting software execution codes on the transmission apparatus 600 side. Also, since the transmission apparatus 600 includes software and arithmetic circuits that perform arithmetic processing for the control functions for each of the optical interface units A to C that are in production at the time of development, even if any of optical interface units A to C is attached to the transmission apparatus 600, the transmission apparatus 600 can accept the optical interface unit. For example, even where the optical interface unit A is detached and the optical interface unit B is attached, the optical interface unit B can be used without rewriting software execution codes or stopping or re-executing the software. Therefore, the transmission apparatus 600 enables reduction in costs for upgrade of the transmission apparatus 600 body, and for example, can support additional hardware such as the optical interface units B, C.

Also, the optical interface unit X that is not in production at the time of development of the transmission apparatus 600 can be used with no change in software execution codes on the transmission apparatus 600 side and the arithmetic processing hardware 5, and thus, the transmission apparatus 600 can support additional hardware. However, for the optical interface unit X, arithmetic processing for the control functions of the optical module unit and the optical AMP unit is fixed as hardware processing. Therefore, even if there is a change in hardware configuration, the need to re-develop software execution codes can be eliminated, enabling suppression of increase in development costs of the software.

<Others>

In the first embodiment, it is assumed that in the address translation table, an address of a storage area for a code group of a subroutine in the main memory 4 is set as a pre-translation address, and the address of the arithmetic processing hardware 5 is set as a post-translation address. However, the present invention is not limited to this example, either of an address of a storage area for a code group of a subroutine in the main memory 4 and the address of the arithmetic processing hardware 5 may be set as a pre-translation address and a post-translation address in the address translation table.

For example, an address of a storage area for a code group of subroutine A in the main memory 4 may be set as a pre-translation address and an address for a storage area for a code group of subroutine B in the main memory 4 may be set as a post-translation address. For example, if subroutine A is used where the CPU load is low and subroutine B is used where the CPU load is high, switching of the processing can be performed between subroutines A and B according to the CPU load with no change in main routine. Also, for example, where subroutine A used in the main routine is upgraded to subroutine B, the upgrade can be performed without, e.g., change in main routine and re-start of the information processing apparatus 100.

For example, an address of arithmetic processing hardware A may be set as a pre-translation address and an address of arithmetic processing hardware B may be set as a post-translation address. In this case, even if a main routine originally calls arithmetic processing hardware A, arithmetic processing hardware B can be called instead of arithmetic processing hardware A. For example, it is assumed that the arithmetic processing hardware A includes arithmetic circuits for predetermined processing for all of data types irrespective of the data types. It is assumed that the arithmetic processing hardware B includes an arithmetic circuit for predetermined processing that is suitable for audio data. It is assumed that a condition for rewriting a post-translation address in the address translation table to the address of the arithmetic processing hardware B is detection of audio data. In this case, upon audio data flowing in the transmission apparatus 600, a post-translation address in the address translation table is rewritten to the address of the arithmetic processing hardware B, enabling predetermined processing to be switched to processing that is more suitable for audio data.

Also, in the address translation table, the address of the arithmetic processing hardware 5 may be set as a pre-translation address, and an address of a storage area for codes of a subroutine in the main memory 4 may be set as a post-translation address.

All examples and conditional language provided herein are intended for the pedagogical purposes of aiding the reader in understanding the invention and the concepts contributed by the inventor to further the art, and are to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a central processing device;
a storage device configured to store a first instruction group and a second instruction group in a storage area to which a predetermined address range in an address space the central processing device accesses is assigned; and
a circuit configured to execute predetermined arithmetic processing according to an address assigned in the address space,
wherein the central processing device includes
a program counter configured to designate an address in the address space,
a controller configured to output an address obtained as a result of execution of the first instruction group to the program counter, and
a translator including a memory configured to store an address assigned to the circuit as a second address, in association with an address used for execution of the second instruction group, the address being a first address, and configured to, when an address output from the controller matches the first address, output the second address to the program counter.

2. The information processing apparatus according to claim 1, wherein the circuit includes:
an arithmetic circuit configured to perform the predetermined arithmetic processing; and
a control circuit configured to, when a predetermined condition is met, write the address assigned to the circuit to the memory of the central processing device, as the second address.

3. The information processing apparatus according to claim 2, wherein when the predetermined condition is not met, the control circuit writes the address used for execution of the second instruction group to the memory of the central processing device, as the second address.

4. The information processing apparatus according to claim 2, wherein:
the central processing device further includes
an address holder configured to hold an address held in the program counter immediately before the address used for execution of the second instruction group is output from the controller, and
a register configured to store a result of the execution of the second instruction group; and
when the address assigned to the circuit is called by the central processing device, the control circuit of the circuit acquires data from a storage area for the address held by the address holder, outputs the acquired data to the arithmetic circuit to write a result of an arithmetic operation of the arithmetic circuit to the register.

5. The information processing apparatus according to claim 1, wherein while the predetermined arithmetic processing is being executed in the arithmetic circuit as a result of the address assigned to the circuit being called by the central processing device, the control circuit of the circuit returns, in response to a call of the address assigned to the circuit by the central processing device, a dummy instruction for preventing an address in the predetermined address range assigned to the storage device from being called by the central processing device.

6. The information processing apparatus according to claim 2, wherein when addition of the arithmetic circuit is detected, which is a case where the predetermined condition is met, the control circuit of the circuit writes the address assigned to the circuit to the memory of the central processing device, as the second address.

7. The information processing apparatus according to claim 2, wherein:
the storage device stores a plurality of second instruction groups for performing first processing relating to a interface module for plural types of interface modules attachable/detachable to/from the information processing apparatus;
the circuit includes, for the plural types of the interface modules corresponding to the plurality of the second instruction groups, arithmetic circuits configured to perform first processing; and
as the second address, the control circuit writes the address assigned to the circuit at which an arithmetic processing according to a type of an attached interface module is executed, to the memory of the central processing device when the predetermined condition is met, and writes an address used for execution of a second instruction group according to the type of the attached interface module to the memory of the central processing device when the predetermined condition is met.

8. The information processing apparatus according to claim 7, wherein when the control circuit includes no arithmetic circuit according to the type of the attached interface module and the attached interface module includes a second arithmetic circuit configured to perform first processing relating to the attached interface module, the control circuit writes an address assigned to the second arithmetic circuit included in the attached interface module to the memory of the central processing device, as the second address.

9. A central processing device comprising:
a program counter configured to designate an address in an address space the central processing device accesses, the address space including a predetermined address range assigned to a storage area of a storage device in which a first instruction group and a second instruction group are stored, and an address assigned to a circuit configured to execute predetermined arithmetic processing according to the assigned address;
a controller configured to output an address obtained as a result of execution of the first instruction group to the program counter; and
a translator configured to store, as a second address, the address assigned to the circuit in association with an address used for execution of the second instruction group, the address being a first address, and when the address output from the controller matches the first address, output the second address to the program counter.

10. A central processing device comprising:
a program counter configured to designate an address in an address space the central processing device accesses, the address space including a predetermined address range assigned to a storage area of a storage device configured to store a first instruction group and an address assigned to a circuit configured to perform predetermined arithmetic processing according to the assigned address;
a controller configured to output an address obtained as a result of execution of the first instruction group to the program counter; and
a translator configured to store a second address in association with a first address, and when the address output from the controller matches the first address, output the second address to the program counter.
